(19) United States
(12) Patent Application Publication
(10) Pub. No.: US 2006/0259603 A1
(43) Pub. Date: Nov. 16, 2006

(54) USER BASED - WORKFLOW AND BUSINESS PROCESS MANAGEMENT

(76) Inventors: Anthony G. Shrader, Longmont, CO (US); Anthony P. Fox, Denver, CO (US)

Correspondence Address: COCHRAN FREUND & YOUNG LLC, 2026 CARIBOU DR, SUITE 200, FORT COLLINS, CO, 80525, US

(21) Appl. No.: 11/383,357

(22) Filed: May 15, 2006

Related U.S. Application Data
(60) Provisional application No. 60/681,781, filed on May 16, 2005.
(60) Provisional application No. 60/681,797, filed on May 16, 2005.

(51) Int. Cl. G06F 15/173

(52) U.S. Cl. 709/223

(57) ABSTRACT

Disclosed is a business rules workflow system that provides a single communication interface for communications between end user applications, such as an agent user interface, and back office applications. The business rules workflow system also provides a single interface to apply business rules to the end user application to back office application communications. The communications and business rules interfaces reduce the need for multiple user interfaces using multiple technology, thus reducing the complexity, maintenance, and upgrade costs for a typical business environment. The business rules workflow system sends and receives data form pre-existing data systems, converts the pre-existing data system data into a common format, and sends the data to the data consumer. Any business rules based on the pre-existing system data will be applied by the business rules workflow system.

### CROSS REFERENCE TO RELATED APPLICATIONS

This application is based upon and claims the priority to U.S. provisional application Ser. No. 60/681,781, entitled “User Based—Workflow and Business Process Management” by Anthony G. Shrader and Anthony P. Fox filed May 16, 2005, and U.S. provisional application Ser. No. 60/681,797, entitled “BOA Back Office Integration Protocol” by Anthony G. Shrader and Mahendra Kale filed May 16, 2005, the entire contents of which are hereby specifically incorporated by reference for all they disclose and teach.

### BACKGROUND OF THE INVENTION

The business workplace is filled with back office systems that assist call center agents in fulfilling their day-to-day tasks. These back office systems traditionally include, databases, mainframes, file servers, email systems, phone system (CTI), etc. These are just a few of the systems that a user may interact with to satisfy the request of their customers, or accomplish a specific business function. Most of these back office systems communicate with a client-based user interface through a series of messages. A client based application can generate a message requesting information and the back office application responds to the request with a message or messages that facilitate the client request. There is usually a separate user interface and business rules system for each separate back office application that makes up the back office system, thus, multiple user interfaces and business rules implementations are necessary to implement a complex enterprise system made up of multiple back office applications.

### SUMMARY OF THE INVENTION

An embodiment of the present invention may comprise a method of optimizing back office enterprise computer systems to end user computer systems workflow comprising: concentrating workflow communication messages that are transmitted to and from at least one back office application into a single common communication format that is accessible by at least one end user computer application; communicating the workflow communication messages directly to and from the at least one end user computer application in the single common communication format such that the workflow communication messages are not converted into an end user application format prior to being communicated to the at least one end user computer application; and applying user configured business rules to the workflow communication messages formatted with the single common communication format such that the at least one end user computer application behaves in accordance with the user configured business rules.

An embodiment of the present invention may further comprise a business rules workflow system for optimizing back office enterprise computer systems to end user computer systems workflow comprising: a common language message subsystem that concentrates workflow communication messages that are transmitted to and from at least one back office application into a single common communication format that is accessible by at least one end user computer application; and a communication subsystem that communicates the workflow communication messages directly to and from the at least one end user computer application in the single common communication format such that the workflow communication messages are not converted into an end user application format prior to being communicated to the at least one end user computer application; and a business rules interface subsystem that applies user configured business rules to the workflow communication messages that are formatted with the single common communication format such that the at least one end user computer application behaves in accordance with the user configured business rules.

An embodiment of the present invention may further comprise a business rules workflow system for optimizing back office enterprise computer systems to end user computer systems workflow comprising: means for concentrating workflow communication messages that are transmitted to and from at least one back office application into a single common communication format that is accessible by at least one end user computer application; means for communicating the workflow communication messages directly to and from the at least one end user computer application in the single common communication format such that the workflow communication messages are not converted into an end user application format prior to being communicated to the at least one end user computer application; and means for applying user configured business rules to the workflow communication messages formatted with the single common communication format such that the at least one end user computer application behaves in accordance with the user configured business rules.

### BRIEF DESCRIPTION OF THE DRAWINGS

In the drawings,

FIG. 1 is a schematic illustration of a business rules/back office environment using the business rules workflow system.

FIG. 2 is a schematic illustration of the base communications model of the business rules workflow system.

FIG. 3 is schematic illustration of the detailed communications model of the business rules workflow system.

FIG. 4 is a communications diagram of an example of business rules workflow system business rule usage by the company agent user interface.

FIG. 5 is a communications diagram of an example of business rules workflow system business rule usage by the company agent user interface.

FIG. 6 is a communications diagram of an example of business rules workflow system business rule usage by the company agent user interface.

FIG. 7 is a diagram describing the hierarchal tree node structure of the business rule interface of the business rule workflow system.

FIG. 8 is a diagram describing the data structure of a common language message of the business rule workflow system.

FIG. 9 is a schematic illustration of an embodiment of the business rules workflow system.

FIG. 10 is a schematic illustration of the business rules workflow system exposing a common language message to the business rules administrator user interface.

FIG. 11 is an illustration of an embodiment of the business rules administer user interface exposing a common language message.

FIG. 12 is a diagram showing the workflow actions in the business rules interface of the business rules workflow system.

FIG. 13 is an illustration of an embodiment of the business rules administer user interface showing an example workflow action.

FIG. 14 is an illustration of an embodiment of the business rules administer user interface showing an example of a workflow action path.

### DETAILED DESCRIPTION OF THE INVENTION

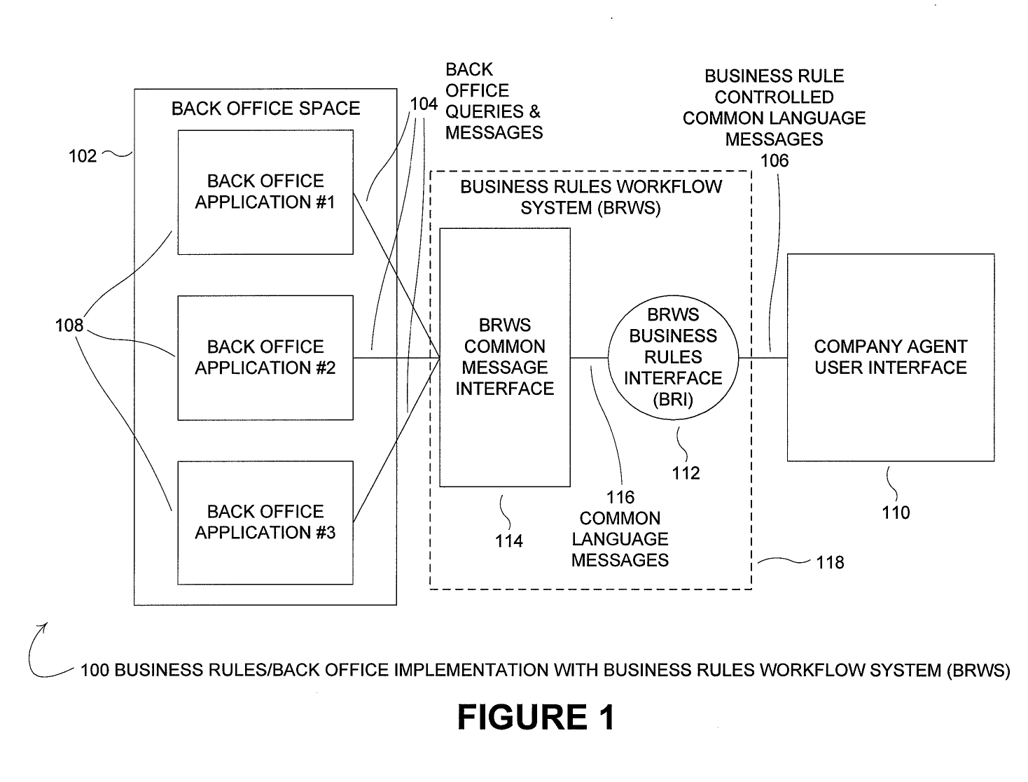

FIG. 1 is a schematic illustration 100 of a business rules/back office environment using the business rules workflow system 118. Typically an employee, also referred to as a company agent or just an agent, must interact with the data stored in the back office space 102. The agent interaction with both the customer and the back office systems 102 is, in essence, a “workflow.” In other words, a “workflow” consists of transactions that will occur in a particular sequence depending on the information provided by the customer and/or the back office application 108. Currently, there is not a solution that manages agent interaction with both the back office applications 108 and the data provided by the customer. Many companies produce work flow engines, or solutions that automate business processes using the rules dictated by the business. The workflow engines provide a means for allowing a non-technical agent or employee to access data stored on technically complex systems without the need for excessive technical training. These workflow systems are typically targeted at a single back office application 108, so a complete office environment might consist of many workflow systems, with each workflow system interacting with a single back office application 108.

The Business Rules Workflow System (BRWS) 118 provides a solution that manages agent interaction with both the back office applications and the data provided by the customer. Many companies produce work flow engines, or solutions that automate business processes using the rules dictated by the business. These solutions do not address the two challenges unique to most business environments, namely, “real time” decisions and “human intervention”. Additionally, these business rules come in the form of an interface which is not directly connected to the systems that the business rules should be managing, specifically the back office applications 108. Many workflow applications use a notification process when a particular function requires authorization by the company management. In modem business, the delay of authorization does not provide the service the customer would expect. Agents of companies need to have definitive responses with the appropriate company policies or business rules applied against the response data. The data must be timely and provided to customers in real-time, such as supplying information when the customer is on the phone instead of waiting to call back. Secondly, human intervention is not a factor in most work flow applications as most workflow applications tend to automate decisions, thus excluding human intervention. In the business environment today, agent interactions with the customer may provide data that should reverse a particular decision, but automated workflows don't afford such flexibility. Most current workflow engines are narrowly defined to handle the agent workflow thru the proprietary applications or interfaces of only the specific workflow system. For instance, the workflow system used to manage an agent using a “softphone” telephony application does not also control the agent when connecting to a legacy server system such as VAX or Tandem systems. Hence, multiple workflow systems must be used, or the agent is limited to only workflow associated with a particular BackOffice connection.

Most back office applications 108 are considered Client/Server applications where the server resides in the back office space 102 and the client is the end user application 110 that accesses data stored on the servers 108. In any standard Client/Server environment all communication is facilitated using three basic communication methods: Request/Response, Request/No Response, and Unsolicited Message. For Request/Response, the client application will make a synchronous or asynchronous request for data (or to execute a Function) and receive a response message back from the server application. For Request/No Response, the client application can send a request for an action which does not require the server application to generate a response. For Unsolicited Message, the client application does not make a request, but the server application can send an Unsolicited Message to the client application as the server application deems necessary.

It is generally assumed that any Request, Response Message, or Unsolicited Message contains data that would or could be broken up into logical groupings (or fields) and that these logical groupings or fields contain data. It is not generally assumed that the actual message would necessarily contain the field name or identifier, simply that the data contained in the message may be grouped in such a fashion. For most business environments, Clients or Servers must communicate to multiple other Clients or Servers. Also, typical communication between Client and Servers may require that “business rules” be applied in order to determine how a Client or Server reacts to a particular Request, Response, or Unsolicited Message. Generally, business rules are “embedded” into the Clients, Servers or both, and changing these rules may require significant technology changes on multiple systems. In some cases, a “Proxy” system may sit between a single Server and multiple Clients. This system architecture, known as a “Three Tier” architecture, is commonly used by Database systems to control the number of clients connecting to the primary database engine. In this three tier architecture it is possible to assert business rules against the Client/Server communication. Usually the rule handling is located in the Proxy system, and Client/Server applications are not aware of the business rule, and the Client/Server applications do not typically have an opportunity to react independently to a Request, Response or Unsolicited Message. By and large, when new Clients or new Servers are introduced to the existing Client/Server system, integration between the new Clients/Servers and the original system is necessary to facilitate proper system function.

In the Business Rules Workflow System (BRWS) 118, the agent application 110 resides behind the business rules workflow system 118. The business rules workflow system 118 allows a single point of connection 114 for the client to access all back office applications 108. A common message format 116 is also included for all back office applications 108, regardless of type. The single point of connection 114 and common message format 116 are the key to allowing the business rules workflow system 118 to define a single, common set of business rules 112 which drive the client workflow. Because all messages 104 to/from the client are in the common message format 116, a common business rule format 112 which adheres to this common message format 116 is defined. The common message format 116 allows the business rules workflow system 118 business rules 112 to control the client workflow 106 regardless of message 104 origin or purpose.

In the business rules workflow system 118, client applications 110 may be coded to use the business rules workflow system 118 business rules interface 112 and message format to handle all workflow in the entire back office space 102. Thus, as new back office applications 108 are added, no code changes in the business rules interface 112 or client application 110 will be required to handle the new back office application 108 in stark contrast to the current workflow environment.

The business rules workflow system 118 creates multiple advantages, including:
A higher-powered server controls the proprietary communication 104 to the back office space 102 and the various proprietary back office applications 108, hence, companies may still use company created proprietary back office applications 108 without being forced to purchase a proprietary workflow solution;
All communications 104 with any back office application 108 is controlled through the business rules interface 112, instead of being disconnected from the communication model, the business rules 112 are brought in synch with changes to the back office applications 108, and since the business rules 112 are separated and not imbedded in the agent user interface 110, changes to the business rules 112 may be made on the fly;
All communication with the agent user interface 110 is through a single connection point 104, using a “non-proprietary” communication model. The agent user interface 110 becomes “thin”, heavy programming is removed from the application 110 running on the low powered PC of the agent/employee, yet the agent/employee is regulated through the separate business rules 112 which may change on the fly; and
There is one common message format 116 and set of business rules 112 that control the workflow of the client application 110, regardless of which back office application 108 is being utilized.

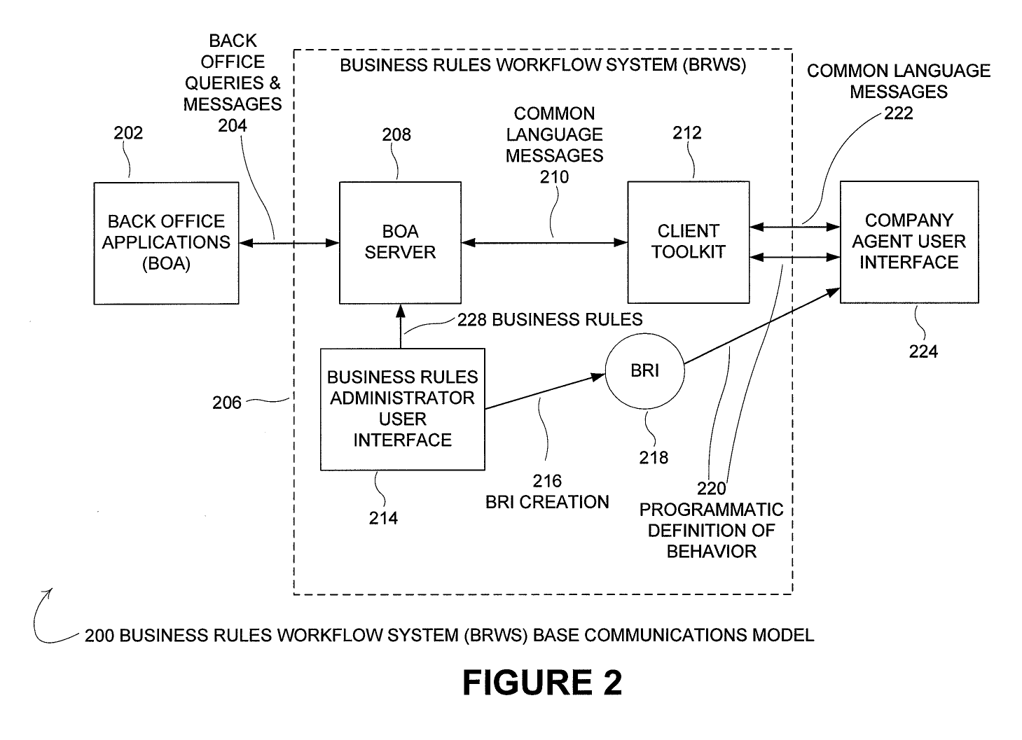

FIG. 2 is a schematic illustration 200 of the base communications model of the business rules workflow system 206. The business rules workflow system 206 is comprised of 5 subsystems: the Back Office Applications (BOA) Server 208, the Common Language Message (CLM) 210, the Business Rules Administrator User Interface 214, the Business Rules Interface (BRI) 218, and the Client Toolkit 212. The business rule subsystems 214, 218 provide the agent application 224 the business process management or workflow 220. The client toolkit 212 provides the connection between the BOA Server 208 and the agent User Interface (UI) application 224 as well as the Business Rule Interface 218 processing. The business rules workflow system 206 does not include the back office applications 202 or the agent UI application 224.

The business rules workflow system 206 is a network based application used to converge multiple third party Back Office Applications (BOA) 202 such as databases, servers, mainframes, e-mail systems, Computer Telephony Integration (CTI) systems and other systems used to support agents in completing their work tasks. Agents communicate through the agent UI application 224 to the back office applications 202 via the business rules workflow system 206 Common Language Message (CLM) 210.

The translation of messages 304 between the back office applications 202 and the agent UI 224 is accomplished by the business rules workflow system 206 BOA Server 208. The BOA Server 208 subsystem is disclosed in the previously mentioned patent application Ser. No. 60/681,797, entitled “BOA Back Office Integration Protocol,” and is not discussed in detail in this application. To summarize the BOA Server 308 translates all proprietary communications 204 of the back office applications 202 obtained via proprietary network connections and delivers common language messages (208) for delivery to the agent UI 224. Therefore, regardless of the kind of back office application 202, connection type, or message/data format, all communications 222 to/from the agent UI 224 are translated into the CLM 210 format.

Business rules are generated and administered by the business rules administrator user interface 214 based on the messages 228 stored by the BOA Server 208. Once the business rules 328 have been defined by the business rules administrator user interface 214, the business rules administrator user interface 214 creates 216 the BRI 218 which is read by the agent UI 224. The BRI 218 provides a programmatic definition 220 for how the agent UI 224 behaves. The agent UI 224 passes 220 the BRI 218 to the client toolkit 212.

When the agent UI 224 receives a message 222 it passes the CLM 222 to the client toolkit 212. The client toolkit 212 applies the BRI 218 to the CLM222 to determine what workflow tasks must be performed for this CLM 222. When necessary, the client toolkit 212 raises events for the agent UI 212 which control the workflow behavior of the agent UI 224. The agent UI 224 also uses the BRI 218 directly to control the presentation of data from the CLM 212.

When the agent UI 224 wishes to request data, the agent UI 224 begins by verifying the request through the BRI 218 to ensure that the request is allowed for a call on a specific common language message. If the BRI 218 allows the message, then the agent UI 224 sends a message 222, 216 to the BOA Server 208.

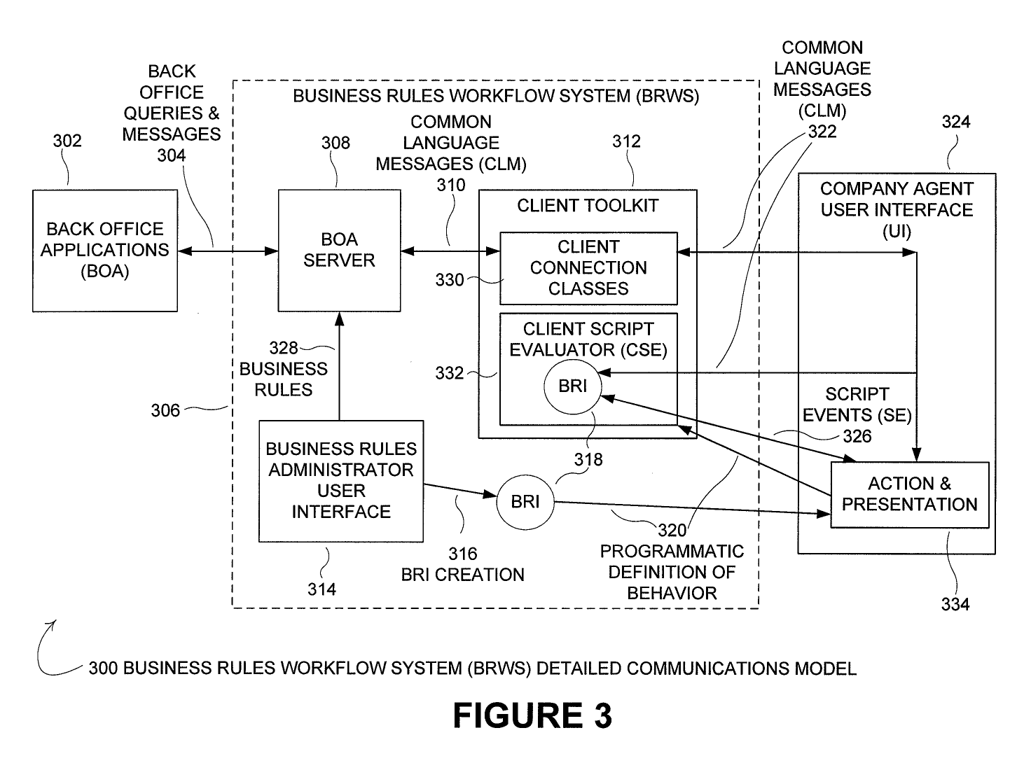

FIG. 3 is schematic illustration 300 of the detailed communications model of the business rules workflow system 306. The common language format 310, 322 of the of the business rules workflow system 306 messages 310, 322 ensures that all messages 304 from all back office applications 302 arrive at the agent UI 324 in a common language format 310, 322. The CLM messages 310 are also exposed 328 to the business rules administrator user interface 314 which allows a user administrator to create business rules based on the common language format 310, 322. The business rules 328 are then exported to create a 316 “business rule document” called the BRI 318. The BRI 318 is a reference interface for the agent UI 324 so that the agent UI 318 may receive the proper business rules programming instruction 320. The agent UI 324 uses the client toolkit 312 to ease the interpretation of the BRI 318. The client toolkit 312 is composed of two distinct subsystems: the Client Connection Classes (CCC) 330 and the Client Script Evaluator (CSE) 332.

The agent UI 324 starts by loading the client toolkit 312. Then the agent UI 324 uses the client connection classes 330 to establish a connection to the BOA Server 308. Next, the agent UI 324 loads 320 the BRI 318, and passes 320 a copy of the BRI 318 to the client script evaluator 332. The agent UI is now ready to send and receive CLM 322 communications with the BOA Server 308.

When the BOA Server 308 sends a CLM 310, the CLM 310 is received by the client connection classes 330, which are then passed to the agent UI 324. The agent UI 324 then immediately passes the CLM 322 to the client script evaluator 332. The client script evaluator 332 applies the BRI 318 to the CLM 322. Specifically, the client script evaluator 332 identifies any business rules associated with the CLM 322 and passes instructions 326 to the agent UI 324, 334 about what actions should be performed for this CLM 322. The client script evaluator 332 does controls the agent UI 324 action and presentation engine 334 by passing Script Events (SE) 326 to the agent UI 324. The script events 326 tell the agent UI 324 what actions need to be performed by the action and presentation engine 334, such as display a message, ask a question, or display a data presentation screen to the agent. In other words, the script event 326 tells agent the UI 324 exactly what to do with the CLM 322 and what actions must be performed by the action and presentation engine 334 of the agent application 334.

The communication 326 between the client script evaluator 332 and the agent UI 324 is bidirectional, so not only may the client script evaluator 332 pass a script event 326 to the agent UI 324, but the client script evaluator 332 may pass a script event 326 that requires a response. The agent UI application 324 may be any type of application such as an automated database application or any other application that needs access to the back office applications 302 and/or the BRI 318.

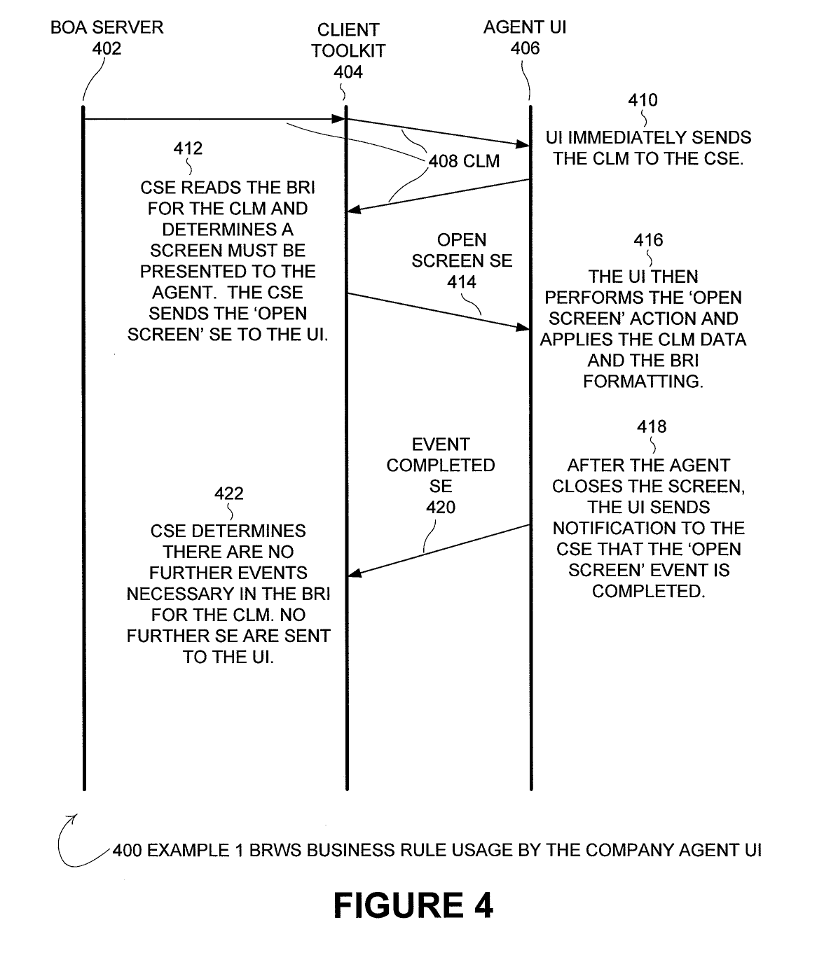

FIG. 4 is a communications diagram 400 of an example of business rules workflow system business rule usage by the company agent user interface 406. The BOA Server 402 delivers a CLM 408 to the client toolkit 404. The client toolkit 404 then passes the CLM 408 on to the agent UI 406. 410 The agent UI 406 immediately sends the CLM 408 to the client script evaluator. 412 The client script evaluator reads the BRI for the CLM 408 and determines a screen must be presented to the agent. The client script evaluator sends the ‘open screen’ script event 414 to the agent UI 406. 416 The agent UI 406 then performs the ‘open screen’ action and applies the CLM 408 data and the BRI formatting to the screen. 418 After the agent closes the screen, the agent UI 406 sends notification 420 to the client script evaluator that the ‘open screen’ event 414 is complete. 422 The client script evaluator determines that there are no further events necessary in the BRI for the CLM 408 and no further script events are sent to the agent UI 406.

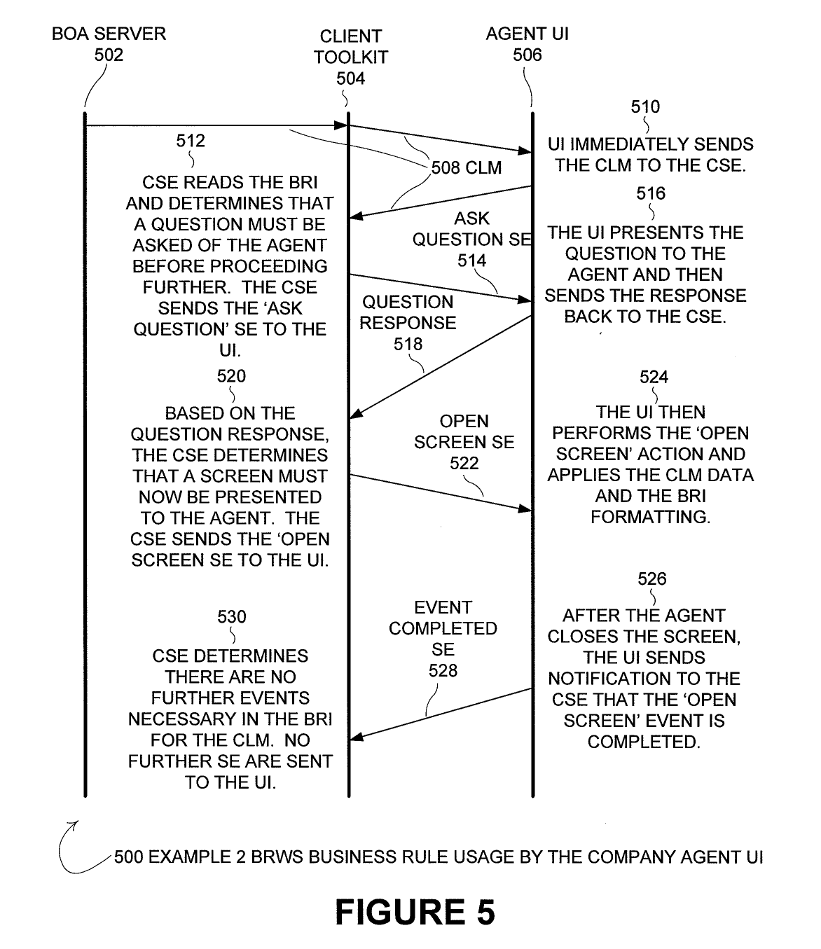

FIG. 5 is a communications diagram 500 of an example of business rules workflow system business rule usage by the company agent user interface 506. The BOA Server 502 delivers a CLM 508 to the client toolkit 504. The client toolkit 504 then passes the CLM 508 on to the agent UI 506. 510 The agent UI 506 immediately sends the CLM 508 to the client script evaluator. 512 The client script evaluator reads the BRI and determines that a question must be asked of the agent before proceeding further. The client script evaluator sends the ‘ask question’ script event 514 to the agent UI 506. 516 The agent UI 506 presents the question to the agent and then sends the question response 518 back to the client script evaluator. 520 Based on the question response 658, the client script evaluator determines that a screen must now be presented to the agent. The client script evaluator send the ‘open screen’ script event 522 to the agent UI 506. 524 The agent UI 506 then performs the ‘open screen’ action and applies the CLM data and the BRI formatting. 526 After the agent closes the screen, the agent UI 506 sends notification 528 to the client script evaluator that the ‘open screen’ event 522 is complete. 530 The client script evaluator then determines that there are no further events necessary in the BRI for the CLM 508. No further script events are sent to the agent UI 506.

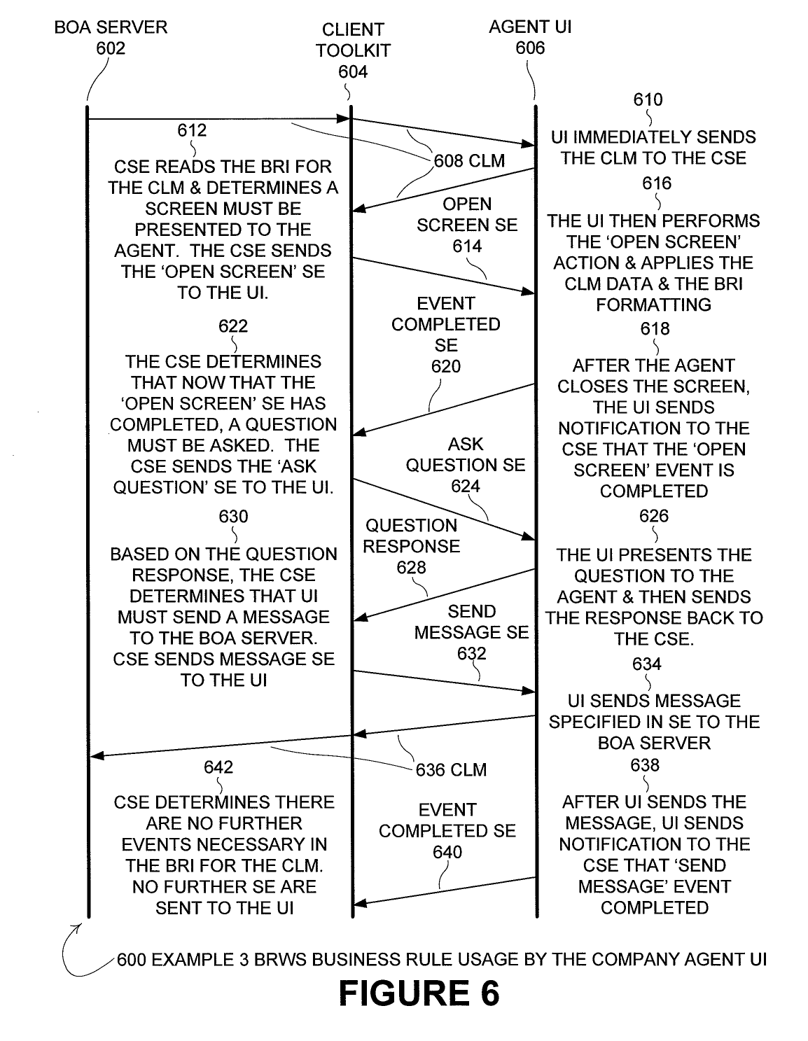

FIG. 6 is a communications diagram 600 of an example of business rules workflow system business rule usage by the company agent user interface 606. The BOA Server 602 delivers a CLM 608 to the client toolkit 604. The client toolkit 604 then passes the CLM 608 on to the agent UI 606. 610 The agent UI 606 immediately sends the CLM 608 to the client script evaluator. 612 The client script evaluator reads the BRI for the CLM 608 and determines a screen must be presented to the agent. The client script evaluator then sends the ‘open screen’ script event 614 to the agent UI 606. 616 The agent UI 606 then performs the ‘open screen’ action and applies the CLM data 608 and the BRI formatting. 618 After the agent closes the screen, the agent UI 606 sends notification 620 to the client script evaluator that the ‘open screen’ event 614 is complete. 622 The client script evaluator then determines that now that the ‘open screen’ script event 614 has completed, a question must be asked of the agent. The client script evaluator then sends the ‘ask question’ script event 624 to the agent UI 606. 626 The agent UI 606 presents the question to the agent and then sends the response 628 back to the client script evaluator. 630 Based on the question response 628, the client script evaluator determines that the agent UI 706 must send a message to the BOA Server 602. The client script evaluator then sends a message script event 632 to the agent UI 606. 634 The agent UI 606 then sends the message 632 specified in the message script event 632 to the BOA Server 602 via the client toolkit 604. 638 After the agent UI 606 sends the message 636, the agent UI 606 sends notification 640 to the client script evaluator that the ‘send message’ event 632 is complete. 642 The client script evaluator determines that there are not further events necessary in the BRI for the CLM 608. No further script events are sent to the agent UI 606.

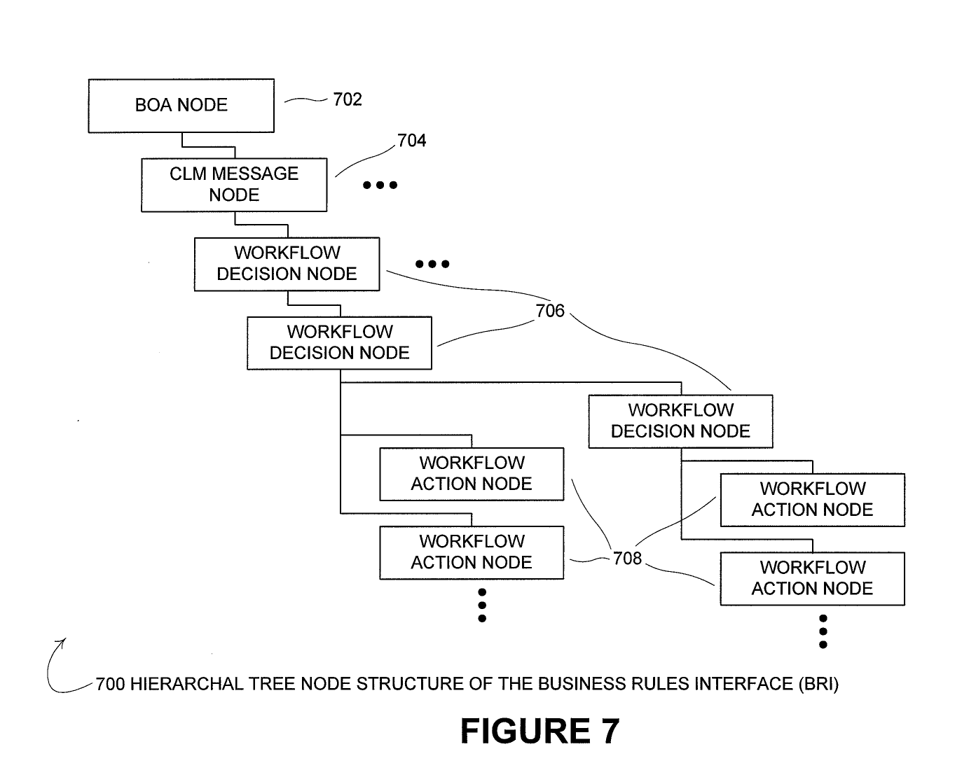

FIG. 7 is a diagram 700 describing the hierarchal tree node structure of the business rule interface of the business rule workflow system. The BRI follows a hierarchal “tree node” type structure 700. The BRI is organized so that an incoming CLM to the agent UI may be matched to a message in the BRI. The BRI then uses child tree nodes for the matching message to navigate to the proper workflow action 708. The workflow tree nodes contain the actions that control the agent workflow for a message. The child workflow decision nodes 706 can be nested recursively as deep as the user would like to define. A BOA node 702 may have multiple CLM message nodes 704. By matching the incoming CLM in the agent UI to a CLM message node 704 defined in the BRI, each child workflow node 706, 708 may be evaluated in sequence until a terminal point is reached.

Workflow paths associated with a CLM do not have to be simple linear paths. The workflow paths may branch apart, so one CLM may be split into multiple pathways, based on either automatic evaluation of the BRI or by user interaction in the agent UI. Workflow decision nodes 706 are nodes where multiple workflow pathways may be defined in the BRI. Workflow action nodes 708 are an indication that some action needs to be performed, such as display a screen or a message. The workflow action nodes 708 do not have a conditional next step based on any interactive or evaluative activity performed. Therefore a workflow action node may only have one child workflow node 706, 708, either another action node 708 or a decision node 706. Workflow decision nodes 706 may have one or any number of child action nodes 708, or other decision nodes 706. Decision nodes 706 are controlled by the type of decision node 706 and the desired number of pathways. Decision nodes 706 must make pathway decisions by either interactive or evaluative activity, such as asking a question of the user or conditionally evaluating a CLM field.

Each node in this hierarchy tree 700 has it unique attributes for each particular node type. For example, the attributes of the workflow action node are different then those of the CLM node. To match the incoming CLM in the agent UI to a CLM defined in the BRI, the message header section of the CLM received by the agent UI must be matched to the message header of the CLM defined in the BRI.

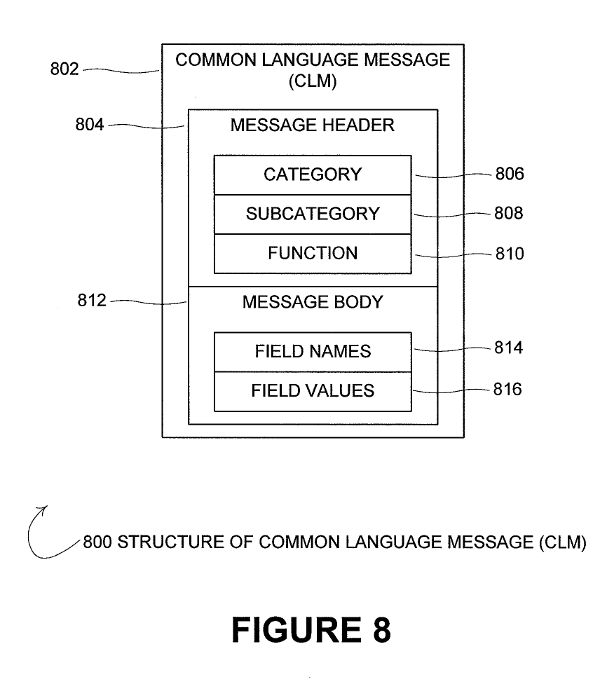

FIG. 8 is a diagram 800 describing the data structure of a common language message 802 of the business rule workflow system. The Message Header 804 contains the fields necessary to make a unique match to an incoming CLM 802. Specifically the header contains the Category 806, Subcategory 808, and Function 810 fields. The fields 806, 808, 810 exist in both the CLM 802 and the BRI as a CLM tree node. The Message Body 812 is composed of Field Names 814 and Field Values 816, in name/value pairings. 814, 816 are the actual data fields of a CLM 802 and will be used by the BRI for conditional evaluation and for displaying data in the agent UI.

The Category numeric code provides the primary identification for a particular message. The Category 806 indicates what back office application the message 802 is associated with, hence, the Category value 806 must be in the defined range of Category codes for the associated back office application.

The Subcategory code is used to define variations of the primary Category 806 message 802. For example, a basic Category ‘100’ message might be defined, but there may be three variations of the message, each with different data fields, for this main Category ‘100’ message. The Subcategory 808 might be assigned Subcategory 808 values of 1, 2, and 3.

The Function code indicates the type of message 802. A Function 810 value of 1 indicates a request message, which means the message was sent by the agent UI to the BOA Server to ultimately go to a back office application. A Function 810 value of 2 or greater indicates the message 802 is from a back office application and the message 802 was sent thru the BOA Server to the agent UI, and is typically a response message to a request message sent by an agent UI or an event message which was sent to the agent UI unsolicited.

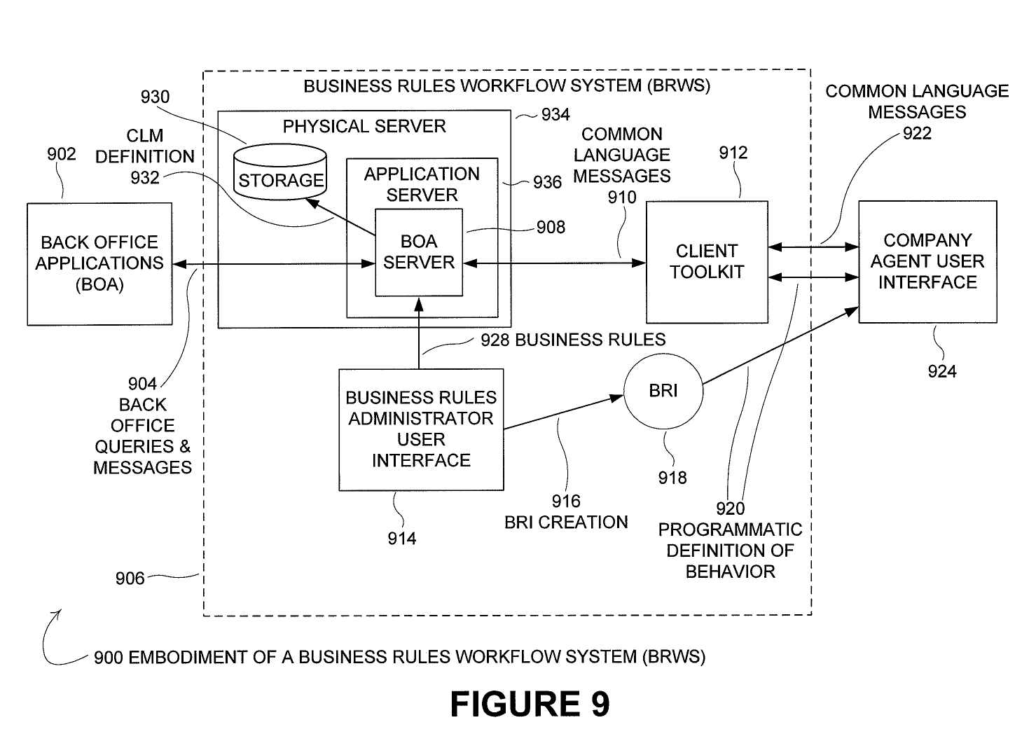

FIG. 9 is a schematic illustration 900 of an embodiment of the business rules workflow system 906. The JAVA—based business rule workflow system 906 resides on a Server-based platform 934. The operating system software of the physical server 934 is immaterial to the proper function of the business rules workflow system 906. The business rule workflow system 906 and BOA Server 908 reside within the boundaries of a JAVA based, Application Server 936. The make and manufacturer of the Application Server 936 is immaterial to the proper function of the business rule workflow system 906.

The back office application 902 is a proprietary third party application providing an open interface that communicates 904 via TCP/IP or some other proprietary network communications interface. As the business rules workflow system 906 is strictly providing a protocol, the back office applications 902 are immaterial to the proper function of the business rules workflow system 906. The back office applications 902 reside outside the boundaries of the physical server 934. The BOA Server 908 resides within the physical server 934 and an Application Server 936, such as an Enterprise JAVA bean. The BOA Server 908 communicates 932 to the business rules workflow system 906 storage 930. The business rules workflow system 906 storage 930 may be a relational database, the make and manufacturer is immaterial to the proper function of the business rules workflow system 906. The storage 930 may also be a static XML file, or any other storage medium. The BOA Server 908 communicates 932 to the storage 932 in order to retrieve the definition 1032 of the CLM 1010, 1022 structure. An embodiment of the CLM 910, 922 structure may be created using XML, but does not have to be XML. The definition for the CLM 910, 922 structure is stored in the business rules workflow system 906 storage 930. Specifically the storage 930 provides the structure, tags and any data that may be manipulated, such as creating a subcategory.

The business rules administrator user interface 914 is a GUI based application which allows users to interact with and create 916 the BRI 918 in an intuitive manner that structurally resembles the actual BRI 918 data structure. The business rules administrator user interface 914 GUI may be written in Microsoft .NET, HTML (Web Application), Java, or any other desired language.

The business rules administrator user interface 914 retrieves 928 the CLM 910, 922 definitions previously stored from the business rules workflow system 906 storage 930 through the business rules administrator user interface 928. After the business rules 928 of the messages are retrieved, the messages 928 are presented to the business rules administrator 914 user in order to allow the user to write a business rule for the message type. The business rules 916 are simple expressions based on a specific message. The business rule 916 defines how the agent UI 924 should behave for a particular message 922, by controlling the content of the message 922, format of the fields and data of the message 922, automating messages 922 and notifying the agent of administrative user information. Once the rule 916 is completed it is stored in the BRI 918 document. The BRI 918 document is the BRI definition 920 which the agent UI 924 receives for programming instructions for each CLM 910, 922 received through the BOA Server 908.

An embodiment of the business rules workflow system 906 includes the proxies generated in a third party bridging application developed by JNBridge. The bridging application allows Microsoft .Net languages to talk to the JAVA application server. The proxies are included in the Client Toolkit 912. JNBridge, LLC is 3024 Jefferson Street, Boulder, Colo. 80304, telephone number 303-545-9371, and web site www.jnbridge.com.

An embodiment of the agent UI 924 connection to the BOA Server 908 is to connect via the business rules workflow system 906 client toolkit 912. The client toolkit 912 provides java connection classes for Microsoft .Net, Java, and web applications. Also, the client toolkit 912 provides client connection classes for .Net classes, for Visual Basic Net or any .Net language to connect to the BOA server 908. Additionally, the client toolkit 912 provides client script evaluation classes in .Net only. Again, all .Net classes that must connect to the BOA Server 908, such as the client connection classes use a third party bridging application developed by JNBridge. The agent UI 924 is typically a client base application, although there is no limitation as to the purpose of the agent application 924. In fact the agent application 924 may not be an actual user interface, but may be any application interested in CLM 922 messages, such as an external database used for reporting. The agent application 924 must be “XML-enabled”, so the agent application 924 might range anywhere from an Internet browser to a Visual Basic application.

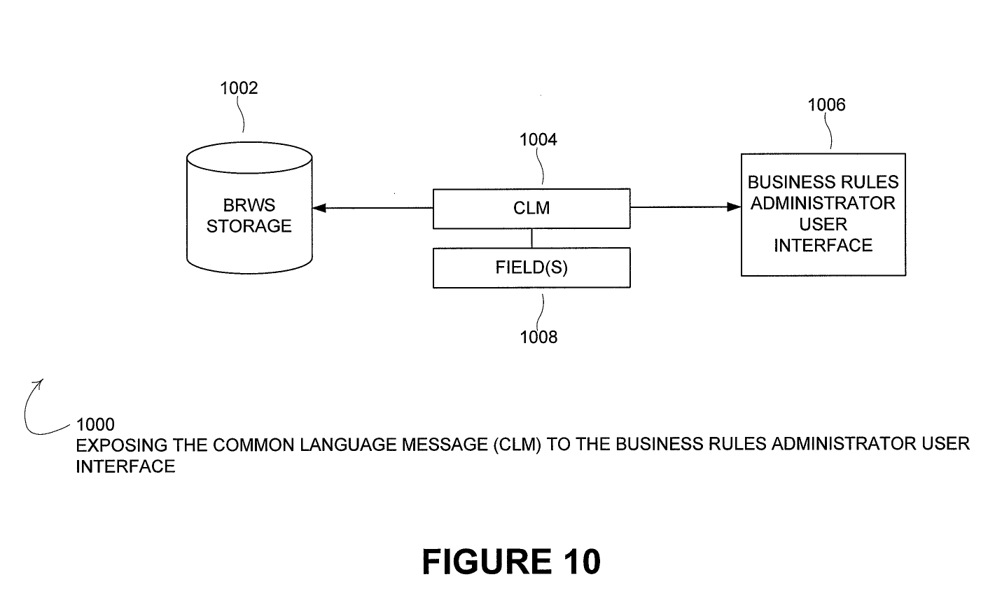

FIG. 10 is a schematic illustration 1000 of the business rules workflow system exposing a common language message 1004 to the business rules administrator user interface 1006. An embodiment of the business rules administrator user interface 1006 is as a windows based GUI application, such as a Microsoft .Net windows application using a Windows to JAVA Bridge protocol, which may include CORBA, or other proprietary applications like JCOM or JNBridge. The business rules administrator user interface 1006 may be written as a browser or java language application as well. The most important consideration is that the administrator tool 1006 has the following properties:

1. Be graphical in nature or a “GUI”;

2. Have an intuitive structure that resembles the structure of the BRI; and

3. The ability to generate the BRI in the format required by the agent UI.

The business rules workflow system uses the CLM 1004 as the basis for the creation of business rules. The business rules workflow system creates a common language interface not just for the benefits of the agent UI, but also so that the business rules workflow system will have a common translation of all back office application messages that business rules may be written against. Put another way, since all CLM 1004 messages are in a common format regardless of the back office application associated with the message 1004, a single Business Rule Interface and business rules administrator user interface 1006 can handle all the rules for the disparate systems.

The business rules administrator user interface 1006 retrieves the formats of the CLM 1004 stored in the business rules workflow system storage 1002 and exposes the CLM 1002 messages and the CLM 1002 fields 1008 formats to the user through the business rules administrator user interface 1006. The user may then create conditional statements or business rules for the individual messages 1004 creating the coupling between the business rules definition and the messages coming from the business rules workflow system.

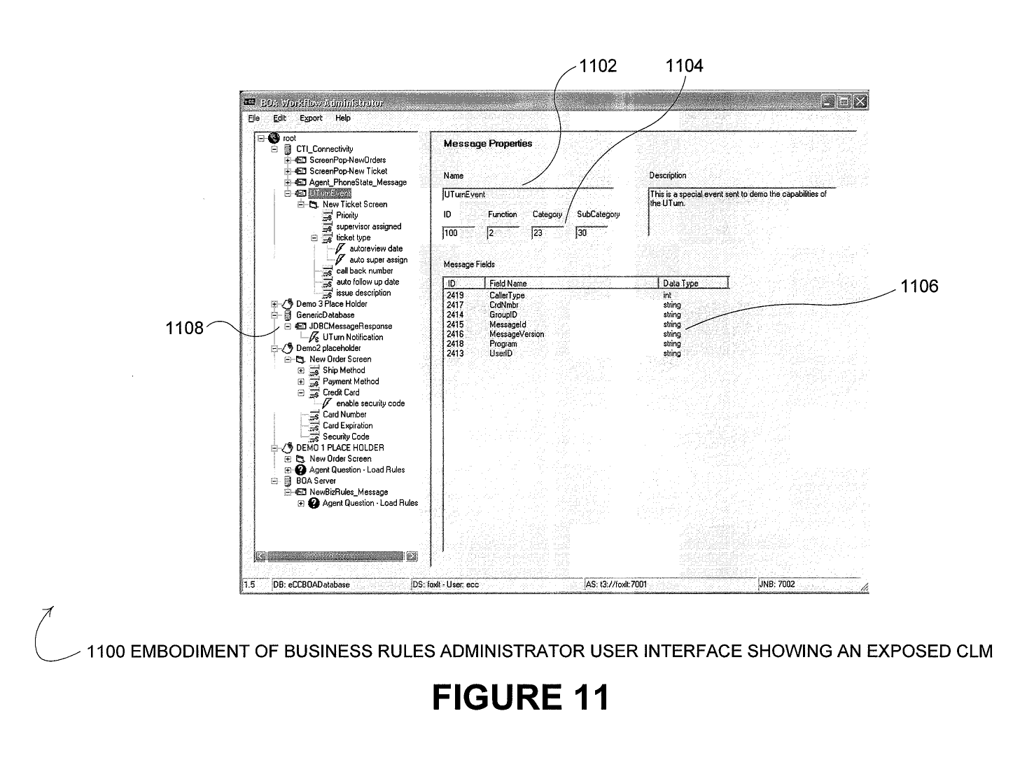

FIG. 11 is an illustration 1100 of an embodiment of the business rules administer user interface exposing a common language message. 1102 is an example name of a Message exposed by the business rule administrator user interface. 1104 are examples of exposed Category and Function codes contained in the descriptor of a CLM. 1106 are examples of exposed Fields and the associated Data Types of a CLM. The Field names and their associated Data Types are also stored in the BRI. 1108 is an example of the hierarchal ‘tree node’ structure of the BRI exposed in the business rules administrator user interface. Once the user has selected a particular CLM, the user may assign the execution of a business rule, also called a “workflow action.”

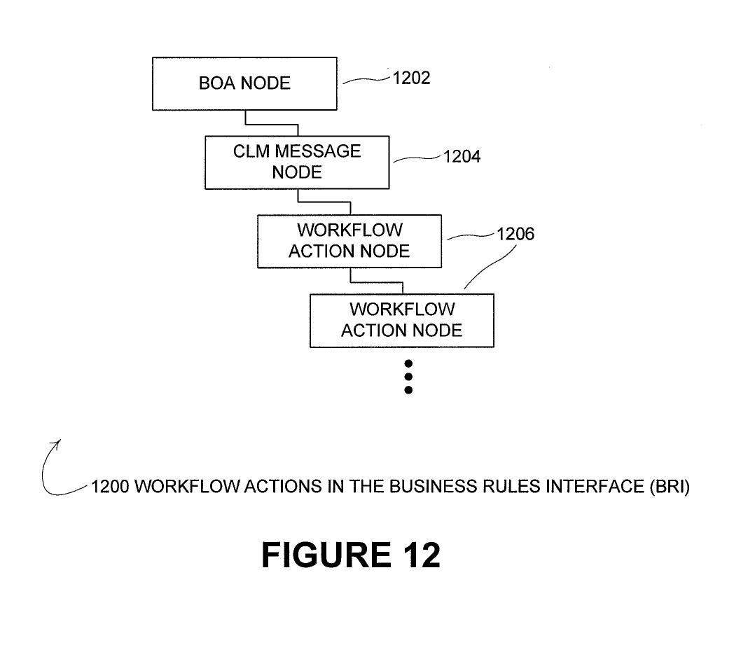

FIG. 12 is a diagram 1200 showing the workflow actions in the business rules interface of the business rules workflow system. The reaction to a CLM is the execution of a business rule or workflow action. FIG. 1200 illustrates the general hierarchal structure of the workflow actions. Basically, a BOA node 1202 contains CLM message nodes 1204 that contain the workflow actions 1206 which can be nested in sequence as deep as needed to create a workflow sequence which must be performed in the agent UI. Workflow actions 1206 against messages are defined by the business rules administrator user interface and stored in the BRI. Workflow actions 1202 instruct the agent UI how to behave when receiving a particular CLM message. An embodiment currently supports multiple action types which are all exported by the business rules administrator user interface to the BRI.

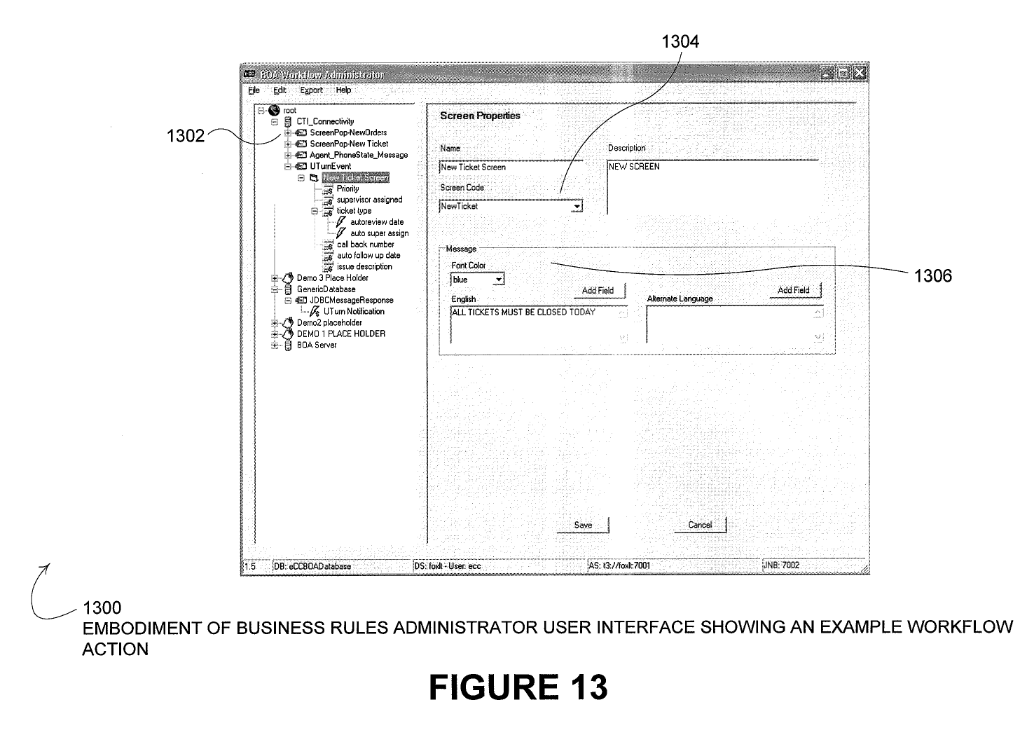

FIG. 13 is an illustration 1300 of an embodiment of the business rules administer user interface showing an example workflow action. 1302 is an example of the hierarchal ‘tree node’ structure of the BRI exposed in the business rules administrator user interface. The ‘New Ticket Screen’ is selected, and the properties of this workflow action are shown to the right. 1304 is an example of the workflow name and code showing a reference to a particular screen in the agent UI. 1306 is an example of the workflow action properties. In this case, the properties are screen messages. In this particular example the user chose to have a specific agent UI screen displayed as an action to the receipt of the example CTI BeginCall Message which is called “UturnEvent.” The screen code is a reference within the agent UI to that particular screen. Codes are used in the BRI to identify various objects that should be contained in the agent UI. As an option to this particular screen the business rules workflow system provides the option of a “Screen Level Message” which may be created by the user and stored in the BRI. The contents of the text may be displayed to the user of the agent UI. FIG. 13 is an example of how the BRI might define properties of the various objects contained within the agent UI.

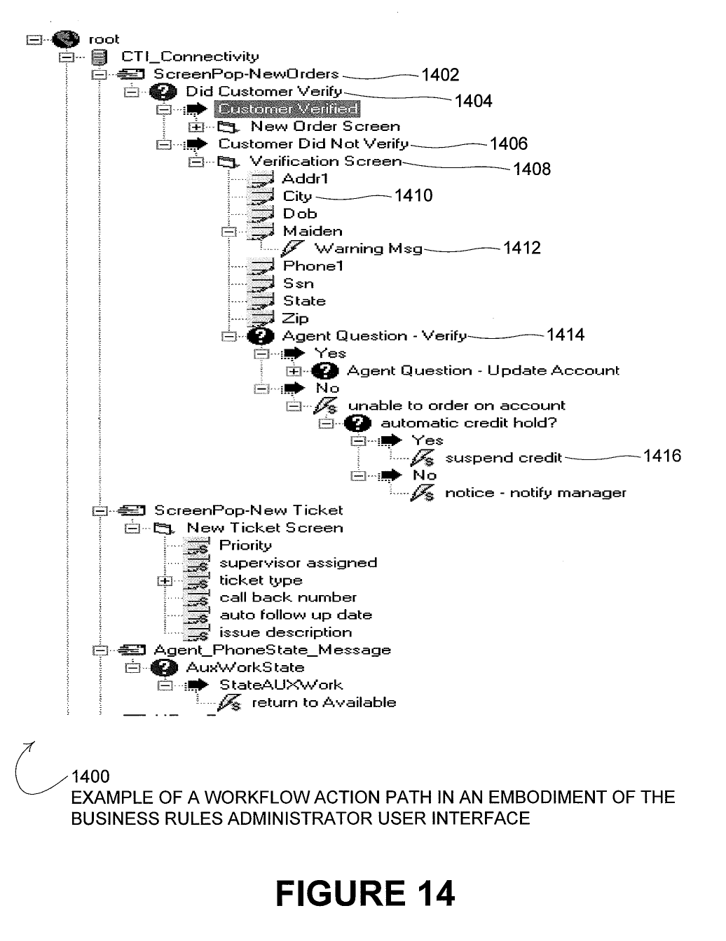

FIG. 14 is an illustration 1400 of an embodiment of the business rules administer user interface showing an example of a workflow action path. 1402 shows the CLM message which is the entry point of this workflow path. Here, the path is selected when the agent UI receives the “ScreenPopNewOrders” message. 1404 is a Condition workflow action used to evaluate values in the CLM received by the agent UI. The conditional evaluation will lead to any number of child case statements, each representing a different path for the workflow based on the evaluation. 1406 is a case workflow action. Case actions are always child cases of a parent condition action, and are used to represent a path to take based on the condition evaluation. 1408 is a screen workflow action indicating that a particular screen must be presented to the agent in the agent UI. 1410 are the fields associated with the parent screen. From here the user in the business rules administrator user interface can control what data elements from the CLM are to presented on the screen, what other controls are visible, and the properties of the controls. 1412 is a field action which instructs the agent UI to perform some presentation action based on the agent selecting this particular field in the agent UI. 1414 is a question action which represents that a Yes/No question should be presented to the agent in the agent UI. The action, like the condition, represents multiple paths that may be navigated depending on the response to the question. 1416 is a script event action which is a general purpose action node with the following types associated with the script event: send message—instructs the agent UI to send a message to the BOA Server; disable message—disables the agent UI ability to send a specific CLM; enable message—enables the agent UI to be able to send a specific CLM; enable all messages—enables all previously disabled messages to be sent in the agent UI; display message—instructs the agent UI to present an information message to the agent; and reload script XML—instructs the agent UI to reload the BRI rules. Some actions, such as conditions, are evaluations based on examining data elements in the CLM and do not require agent input in the workflow. Other actions, like questions and screens, require user interaction in the workflow process.

The BRI follows a “tree node” type structure with the basis of all messages being the ID created by the Category, Subcategory, and Function codes. These codes are retrieved by the business rules administrator user interface from the BOA Server.

One embodiment of the BRI is an XML document, which is a static text file created by the business rules administrator user interface and distributed to the agent UI via the network or other communications path. XML structure follows a free-form, hierarchal recursive structure which is optimally suited to represent the BRI nested, hierarchal structure. Also, since the one embodiment of the CLM is XML, implementation easier if the BRI is also stored as XML.

The following disclosure details the XML format of the one embodiment of the BRI XML format. The disclosure is broken up by the major node types: root, Enterprise JavaBeans, message, condition, case, question, script event, screen, field, and field action. Use the following list to interpret the XML formatting in the following disclosure:
Normal text=Literal character data, such as xml tag names;
italic text=Places where the actual instance data will be inserted—examples are node <name> or <description> tags;
{option1, option 2, . . . }=Indicates a choice between multiple options—only one of the listed values can exist;
*=Placeholder representing the contents of a tag used to show that a tag has some content (child tags), but is not defined in this section—usually, because the contents of this kind of tag are defined in a different section; and
Underline text=Indicates a tag is optional, for example, if a screen element does not have a message, no <screen_message> tag will be sent, however, if a screen element does have a message, then the <screen_message> tag and all child tags will be sent—also, some tags, such as <description> are optional because they don't contain any information required by the client to perform scripting, but are merely informational and may not be included in the XML scripting file.

Note that the nodes defined in the following section are examples of the preferred embodiment of the BRI, however, other node types with their own attributes are possible. However, the node types and contents are not as important as the overall hierarchal message based structure of the BRI itself.

<root> Element

The <root> tag element is the highest point in the xml file and the container for all other data.

XML Format

```
<root VERSION=“1.0”>
        <ejb ID=”999”>
    *
        </ejb>
        .
        .
</root>
```

Attributes
VERSION—The version # of the particular BRI XML file. Each BRI XML file has its own version #.

Child Elements
<ejb>—Tags for all BOA referenced from the BRWS storage which have been selected for scripting. This tag is defined in the next section.
   <ejb> Element

The <ejb> tag element represent the BOA components which have been installed in the BOA Server environment. Each entry contains all CLM in the category range specified by the mincategory and maxcategory values. All workflow rules messages will exist as child nodes to the <ejb> node in the BRI XML file.

XML Format

```
<ejb ID=“999”>
        <name>BackOffice EJB Name</name>
        <description>BackOffice EJB Description</description>
        <mincategory>99</ mincategory >
        <maxcategory>99</ maxcategory >
        <message ID=”999”>
    *
        </message>
        .
        .
</root>
```

Attributes
ID—database Id field value from the BRWS storage

Child Elements
<name>—name of the BOA (50) ejb
<description>—description of the BOA (50) ejb
<mincategory>—the minimum category in the category range of the BOA (50) ejb
<maxcategory>—the maximum category in the category range of the BOA (50) ejb
<message>—Tags for all messages referenced from the BRWS storage which have been selected for rule scripting and belonging to the category range of the BOA (50) ejb. This tag is defined in the next section.

<message> Elements

The <message> tag elements are the actual CLM message defined and stored in the BRWS storage. One <message> tab will exist per CLM, and will contain all other child XML elements.

<message> tag elements will have a single <condition>, <question>, 20<script_event> or <screen> child element tag. If multiple decision paths are possible under a message, then multiple workflow rule pathways will be defined under the single <condition>, <question>, <script_event> or <screen> child element tag.

XML Format

```
<message ID=”999”>
        <name>Message Name</name>
        <description>Message Description</description>
        <category>99</category>
        <subcategory>99</subcategory>
        <function>99</function>
            <classname>message POJO full classname with
package</classname>
            <field_datatypes>
                <fieldname1>{int, char, string, byte, array, short, long,
float, double, or boolean}</fieldname1>
                <fieldname2>{int, char, string, byte, array, short, long,
float, double, or boolean}</fieldname2>
                .
                .
            </field_datatypes>
            {<condition ID=“999”>
                *
            </condition>
            OR
            <question ID=“999”>
                *
            </question>
            OR
            <script_event ID=“999”>
                *
            </script_event>
            OR
            <screen ID=“999”>
                *
            </screen>}
    </message>
```

Attributes
ID—database Id field value from the BRWS storage

Child Elements
<name>—name of the CLM message
<description>—description of the message
<category>—the category header identifier field of the message
<subcategory>—the subcategory header identifier for the messages
<function>—the function header identifier field of the message, which indicates the message direction (1 for request, 2 for response)<
classname>—the message's POJO classname (package and classname)
<field_datatypes>—This tag lists all scriptable message fields and their Java data types. These are included so that <case>evaluations can correctly evaluate message fields based on their data type. Each scriptable field's name is listed as a separate child tag, and the inner text is the field data type. The field datatype is one of the following:
   int
   string
   char
   byte
   array
   short
   long
   float
   double
   boolean
<message> tags can have 1 and only 1 of the following child tags (can't have both
<condition> child AND a <screen> child for example):
<condition>—decision branch point elements (defined in the next section)<
<question>—decision branch point elements (defined in a following section)<
script_event>—special client-side event elements (defined in a following section)
<screen>—screen elements (defined in a following section)

<condition> Elements

The <condition> tag elements are decision branch points in the xml hierarchy. Conditions will have 1 to N<case> elements as children, each performing a specific logical expression evaluation to determine if the path will be chosen. A <condition> tag structure can best be thought of as a If . . . then . . . elseif logical programming structure (or a Switch . . . case statement in Java, for example).

XML Format

```
    <condition ID=”999”>
            <name>Condition name</name>
            <description>description of conditional branch
point</description>
            <case ID=“999”>
                *
            </case>
            .
            .
    </condition>
```

Attributes
ID—database Id field value from the BRWS storage

Child Elements
<name>—name of the condition
<description>—description condition branch point
<condition> tags can have 1 to N number of <case> child elements:

<case>—decision branch point elements (defined in the next section) The following example illustrates the way a condition works:

```
<condition ID=”999”>
    <name>condition 1</name>
    <description>evaluate the {calltype} field</description>
    <case ID=“1”>
      <name>case 1</name>
      <description>determine if {calltype} field is retail</description>
      <expression>{calltype}=’Retail’</expression>
      <screen ID=”123”>
        *
      </screen>
    </case>
    <case ID=“2”>
      <name>case 2</name>
      <description>default case for all other {calltype} field
values</description>
      <expression></expression>
      <screen ID=”456”>
        *
      </screen>
    </case>
  </condition>
```

In this example, the <condition> has 2 possible branch points or cases; the calltype field=‘Retail’ and all other values. If calltype=‘Retail’, then the screen with Id

=“123” will be opened by the agent UI. If calltype equals any other value (the default 25 case), then the screen with Id=“456” will be opened by the agent UI. More information on <case> elements will be provided in the following <case> element section.

<case> Elements

The <case> tag elements represent the different workflow decision pathways that can be executed from a <condition> branch point. Each <case> can have a logical expression which will evaluate to Boolean true or false. This expression can be an evaluation of any number of fields which exist in the parent message (parent <message>element). The last <case> element can have no defined logical expression (empty <expression> tag) to server as the ‘default’ case or pathway to go down if no other <case> expression is true. This is similar to the ‘default’ case in a switch or select statement in programming terms (or an ‘else’ clause in a if . . . then . . . else statement).

<case> tag elements will have a single <condition>, <question>, <script_event>or <screen> child element tag. If multiple decision paths are possible under a case node, then multiple workflow rule pathways will be defined under the single <condition>, <question>, <script_event> or <screen> child element tag.

<case> tags have an expression defined as a string in the inner text of the <expression> child element. These expressions are logical evaluations which can contain the following reserved symbols and elements:
message field names—fields that exist in the parent message are available for evaluation and must be enclosed in { } brackets (ex. {callType}) logical evaluation symbols—‘=’, ‘<’, ‘>’, ‘<=’, ‘>=’, ‘AND’, ‘OR’, ‘NOT’
parenthesis—‘(’, ‘)’—used to partition logical expressions
single quotes (‘ ’)—used to enclose literal string values The following are examples of valid logical expressions:
{callType}=‘123’
{callVarl}=‘999’ OR {callVarl}=‘123’ OR {callVarl}=‘000’
({callType}=‘123’ OR {callType}=‘456’) AND {verifiedFlag=‘T’ }
{numCallsInQueue}>20 AND {agentstate}=20

XML Format

```
<case ID=”999”>
        <name>Case Name</name>
        <description>Case Description</description>
        <expression>logical string expression</expression>
        {<condition ID=“999”>
            *
        </condition>
        OR
        <question ID=“999”>
            *
        </question>
        OR
        <script_event ID=“999”>
            *
        </script_event>
        OR
        <screen ID=“999”>
            *
        </screen>}
    </case>
```

Attributes
ID—database Id field value from the BRWS storage

Child Elements
<name>—name of the case decision element
<description>—description of the case decision element
   <case> tags can have 1 and only 1 of the following child tags (can't have both a
<condition> child AND a <screen> child for example):
<condition>—decision branch point elements (defined in the previous section)
<question>—decision branch point elements (defined the following section)<script_event>—special client-side event elements (defined in a following section)
<screen>—screen elements (defined in a following section)

<question> Elements

The <question> tag elements are client interactive decision branch points in the BRI XML hierarchy. Questions are nodes which indicate that a question must be asked to the user of the agent UI. Put another way, <question> tags instructs the agent UI to ask the use a question, most likely using a dialog box object. The question requires a Yes or No response. Questions will therefore have a single <question_yes> and a single <question_no> child tag, each representing the pathway taken based on the related response from the user.

<question> tag elements will have a single <condition>, <question>, <script_event> or <screen> child element tag. If multiple decision paths are possible under a question node, then multiple workflow rule pathways will be defined under the single <condition>, <question>, <script_event> or <screen> child element tag.

XML Format

```
    <question ID=”999”>
        <name>Question name</name>
        <description>description of question branch point</description>
        <question_text>Yes/No question to ask client application
user</question_text>
        <question_yes>
            {<condition ID=“999”>
                *
            </condition>
            OR
            <question ID=“999”>
                *
            </question>
            OR
            <script_event ID=“999”>
                *
            </script_event>
            OR
            <screen ID=“999”>
                *
            </screen>}
        </question_yes>
        <question_no>
            {<condition ID=“999”>
                *
            </condition>
            OR
            <question ID=“999”>
                *
            </question>
            OR
            <script_event ID=“999”>
                *
            </script_event>
            OR
            <screen ID=“999”>
                *
            </screen>}
        </question_no>
    </message>
```

Attributes
ID—database Id field value from the BRWS storage

Child Elements
<name>—name of the condition
<description>—description condition branch point
<question_text>—the actual text of the Yes/No question to ask the user
<question_yes>—decision branch point element to be navigated if the user response is ‘Yes’
<question_no>—decision branch point element to be navigated if the user response is ‘No’

The following example illustrates the way a question works:

```
<question ID=”999”>
    <name>question 1</name>
    <description>evaluate the {calltype} field</description>
    <question_text>Has this caller been verified?</question_text>
    <question_yes>
        <screen ID=”123”>
            *
        </screen>
    </question_yes>
    <question_no>
        <screen ID=”456”>
            *
        </screen>
    </question_no>
</question>
```

In this example, the question been presented to the user is “Has the caller been verified? ”. If the user answers ‘Yes’ to the question, then the screen with Id=“123” will be opened by the agent UI. If the user answers ‘No’, then the screen with Id=“456” will be opened by the agent UI.

<script_event> Elements

The <script_event> tag is a special tag which instructs the agent UI to raise an special event to perform some action. These actions can be things like display a message to the user, send a request message, and disable/enable the user's ability to send specific request CLM messages.

<script_event> tag elements will have a single <condition>, <question>, <script_event> or <screen> child element tag. If multiple decision paths are possible under a script event node, then multiple workflow rule pathways will be defined under the single <condition>, <question>, <script_event> or <screen> child element tag.

XML Format

```
    <script_event ID=“999”>
        <name>script event name</name>
        <description>script event description</description>
        <type>{0, 1, 2, 3, 4, or 5}</type>
        <event_parameters>
            {<script_message>messagebox
text</script_message>
            OR
            <disable_message ID=”999”>
                <name>message name</name>
                <category>message category
code</category>
                <function>message function
code</function>
            </disable_message>
            .
            .
            OR
            <enable_message ID=”999”>
                <name>message name</name>
                <category>message category
code</category>
                <function>message function
code</function>
            </enable_message>
            .
            .
            OR
            <send_message ID=”999”>
                <name>message name</name>
                <category>message category
code</category>
                <function>message function
code</function>
                <message_fields>
    <fieldname1></fieldname1>
    <fieldname2></fieldname2>
                    .
                    .
                </message_fields>
            </send_message>}
        </event_parameters>
        {<condition ID=“999”>
          *
        </condition>
        OR
        <question ID=“999”>
          *
        </question>
        OR
        <script_event ID=“999”>
          *
        </script_event>
        OR
        <screen ID=“999”>
          *
        </screen>}
    </script_event>
```

Attributes
ID—database Id field value from the BRWS storage

Child Elements
<name>—name of the script event
<description>—description of the script event
<type>—The type of script event, an integer value between 0 and 4. The type of script event determines whether the <event parameters> tag and is included and which child tags are included in the <event_parameters> tag. The following are the possible script_event types:
   (0) display messagbox—instructs the agent UI to display a text message in the client application, most likely in a dialog box
   (1) send_boa_message—instructs the agent UI to sent the specified request message and any assigned field values
   (2) disable boa_message—instructs the agent UI to disable the users ability to send a specific list of request messages
   (3) enable boa message—instructs the agent UI to enable the users ability to send a specific list of request messages
   (4) enable_all_boa messages—instructs the agent UI to enable the users ability to send all request messages
   (5) reload_script_xml—instructs agent UI to reload the scripting xml file
<event_parameters>—tag contains any parameter tags that are specific to the kind of script event or value of the <type> tag. The following defines the content of the <event_parameters> tag based on the value of the <type> tag:
   (0)—display_messagebox
      <script_message>—text message to display in client application
   (1)—send_boa_message—contains a CLM to be sent by the agent UI, defined as follows:
      <send_message>—message the agent UI will send, has the following child tags:
         <name ID=“999”>—name of CLM to send
         <category>—message category id
         <function>—message function value (should be 1 since it is necessarily a request message)<
         message_fields>—each message field where a value is set is contained as a child tag where the tag name is the field name and the inner text value is the field value
   (2)—disable_boa_message—list of request messages to be disabled, each defined as follows:
      <disable_messsage>—request message to be disabled, contains the following child tags:
         <name ID=“999”>—name of CLM to disable
         <category>—message category id
         <function>—message function id (should be 1 for request)
   (3)—enable_boa_message—list of request CLM to be enabled, each defined as follows:
      <enable_messsage>—node contains the following child tags:
         <name ID=“999”>—name of CLM to enable
         <category>—message category id
         <function>—message function id (should be 1 for request)
   (4)—enable_all_boa_messages—since this type has no parameters, <event_parameters> will not be sent (or will be an empty tag)
   (5)—reload_script_×ml—since this type has no parameters, <event_parameters> will not be sent (or will be an empty tag)<script_event> tags can have 1 and only 1 of the following child tags (can't have both a <condition> child AND a <screen> child for example):
<condition>—decision branch point elements (defined in a previous section)
<question>—decision branch point elements (defined in a previous section)
<script_event>—special client-side event elements (defined in a previous section)
<screen>—screen elements (defined in the following section)

<screen> Elements

The <screen> tag elements are the screens that can be scripted to display in the agent UI. Specifically, <screen> tags will exist for each corresponding screen in the agent UI. The parent <message>, <condition>, <case>, and <question>tags determine the workflow pathway that client applications can take to get to an available screen. This is done by determining what message, fields, field evaluations, and questions are necessary to navigate to the appropriate <screen> element.

A <screen> element can have any number of <field> child elements, denoting message fields to be included on the screen (represented as textbox or combobox controls). Also, <screen> tag elements will have a single <condition>, <question>, <script_event> or <screen> child element tag. If multiple decision paths are possible under a screen node, then multiple workflow rule pathways will be defined under the single <condition>, <question>, <script_event> or <screen> child element tag.

XML Format

```
  <screen ID=“999”>
        <name>screen name</name>
        <description>screen description</description>
        <code ID=”999”>screen code</code>
        <screen_message>
            <font_color>{black, blue, green, or red}</font_color>
            <english>message text</english>
            <spanish>message text</spanish>
        <screen_message>
        <field ID=”999”>
                *
        </field>
        .
        .
        {<condition ID=“999”>
            *
        </condition>
        OR
        <question ID=“999”>
            *
        </question>
        OR
        <script_event ID=“999”>
            *
        </script_event>
        OR
        <screen ID=“999”>
            *
        </screen>}
</screen>
```

Attributes
ID—database Id field value from the database

Child Elements
<name>—name of the functional screen
<description>—description of the functional screen
<code>—unique code value used to match to a screen object in client application
<screen_message>—screen level messages displayed when a screen is opened in the client applicaton. This tag contains the following child elements:
   <font_color>—font color of the message
   <english>—the English UNICODE version of the message
   <Spanish> the Spanish UNICODE version of the message
<field>—the fields which will appear on the screen in the client application
   <screen> tags can have 1 and only 1 of either of the following child tags (can't have both a <condition> child AND a <screen> child):
<condition>—nested decision branch point elements (defined in the previous section)
<screen>—screen elements (defined in the next section)

<field>Elements

The <field> tag elements are the scriptable fields that appear on a functional screen in the agent UI. These fields are associated with screen controls in the agent UI. Fields can be added either from fields defined in the parent message (the parent <message> tag) or as stand-alone fields. Fields added from the parent message will be mapped to data in the message when the screen loads, and when the screen is closed data can optionally be sent back to the backend system. Stand-alone fields are not mapped to fields in the parent message, and therefore only get their content data from the business rules administrator user interface (if any content is assigned at all).

Fields are associated with two types of controls in the agent UI: textbox and listbox. Textboxes can display or accept a single value, whereas listboxes can display a list of values from a drop-down list.

Fields can optionally have content scripted for them if the field is not a message field (<source> is not ‘message’). This content is contained in the <content> child elements. Scripting content allows the field to have a value (or values in the case of a listbox) to be arbitrarily scripted by the BOA Admin application.

Finally, fields can optionally have event actions associated with them, contained in <action> child elements. Event actions allow the scripting of client application behavior based on user interactions with field controls on screens. Actions are defined in the next section.

XML Format

<field ID=“999”>

<name>field name</name>
<description>field description</description>
<source>{message or script}</source>
<xmltag>field xml tag name</xmltag>
<type>{tb or lb}</type>
<datatype>field data type</datatype>
<available>{true or false}</available>
<readonly>{true or false}</readonly>
<font_color>>{black, blue, green, or red}</font_color>
<field_message>

<dialog>

<font_color>{black, blue, green, or

red}</</font_color>

<english>message text</english>
<spanish>message text</spanish>

</dialog>
<instruction>

<font_color>{black, blue, green, or

red}</</font_color>

<english>message text</english>
<spanish>message text</spanish>

</instruction>

</field_message>

<content>

<value code=”value code”>value text</value>
.
.

</content>
<action ID=”999”>

*

</action>
.
.

</field>

Attributes
ID—database Id field value from the database

Child Elements
<name>—name of the field
<description>—description of the field
<type>—field's control type (‘tb’ for textbox or ‘lb’ for listbox)<datatype>—field's data type (string, int, double, float, array, single, byte)
<source>—source for this field, either ‘message’ or ‘script’
<xmltag>—field's xml tag name if source is ‘message’ or control code if source is ‘script’
<available>—true/false determines if the field is visible on the screen or not
<readonly>—true/false determines if the fields is readonly or not (only applies to textboxes)
<font_color>—the font color of the values in the field's control
<field_message>—field level messages displayed when a screen is opened in the client application. This tag contains the following child elements:
   <dialog>—messages displayed in the dialog area of the client application
   <instruction>—messages displayed in the instruction area of the client application
   each <dialog> and <instruction> tag contains the following elements:
      <font_color>—font color of the message
      <english>—the English UNICODE version of the message
      <Spanish>—the Spanish UNICODE version of the message
<content>—if the field's source is script (meaning it is not mapped to a backend system), values can be assigned to the field which will appear in the client application. This element contains 1 to N of the following child elements:
   <value>—text value (if a field is of type textbox, it will only contain 1 <value> element)
<action>—the optional event actions which are assigned to this field control (defined in the next section)

<action> Elements

The <action> tag elements are scripted actions that happen as a result of some event in the agent UI. There are 5 main types of actions: ‘edit content’, ‘edit font color’, ‘edit dialog/instruction’, ‘edit readonly’, and ‘edit available’. The 5 action types correspond to the 5 scriptable properties of a field.

Limitations on <action> elements:
1. Only listboxes can have associated actions. Textboxes are not currently supported. Therefore, no <action> tags can exist in <control > tags.
2. The only supported event for listboxes to scripted actions on is the Update event. This is the event that is fired when a listbox has a value selected. Since the Update event is the only supported event, the <event> tag in the <action> tag can only have a value of “update”. If other events would be supported in the future, this value could be different to support other events.
3. Actions can only update an existing scriptable property of a field Since there are 5 scriptable properties of a control (availability, content, font color, readonly, and messages), there are 5 corresponding action types (edit available, edit content, edit font color, edit dialog/instruction, edit readonly).
4. Action can only update the properties of <field> elements on the same functional screen.
5. Actions can only modify a property of 1 field per action.
6. Actions based on update events can only be triggered by a single value of a listbox update. This means that to trigger and action, a single existing value of a listbox can be selected.
7. No child elements of Actions are optional. For example, if an action is of type ‘edit font color’, even if the proposed font color is ‘black’, the <font_color> black</font_color> tag is still required.

XML Format

<action ID=“999”>

<name>action name</name>
<description>action description</action>
<type>{edit dialog/instruction, edit readonly, edit available, edit

content, or edit font_color}</type>

<event>update</event>
<target ID>target field ID</target>
<cond_value code = “update condition value code”>update

condition value text</cond_value>

{<available>{true or false}</available>
OR
<readonly>{true or false}</readonly>
OR
<font_color>>{black, blue, green, or red}</font_color>
OR
<field_message>

<dialog>

<font_color>{black, blue, green, or

red}</</font_color>

<english>message text</english>
<spanish>message text</spanish>

</dialog>
<instruction>

<font_color>{black, blue, green, or

red}</</font_color>

<english>message text</english>
<spanish>message text</spanish>

</instruction>

</field_message>
OR
<content>

<value code=”value code”>value text</value>
.
.

</content>}

</action>

Attributes
ID—database Id field value from the database

Child Elements
<name>—name of the action
<description>—description of the action
<type>—type of action (edit dialog/instruction, edit available, edit readonly, edit content, or edit font_color)
<event>—event of the parent field which triggers this action
<target ID>—the ID value of the target field control
<cond_value code=“999”>—if the parent field type is a listbox, then the optional selected value to trigger the action in an ‘update’ event and the values code (as an attribute)
the following elements are contained by the <action> element are determined by the <type> tag:
   <available>—true/false determines if the field is visible on the screen or not
   <readonly>—true/false determines if the fields is readonly or not (only applies to textboxes)
   <font_color>—the font color of the values in the field's control
   <field_message>—field level messages displayed when a screen is opened in the client application. This tag contains the following child elements:
      <dialog>—messages displayed in the dialog area of the client application
      <instruction>—messages displayed in the instruction area of the client application
      each <dialog> and <instruction> tag contains the following elements:
         <font_color>—font color of the message
         <english>—the English UNICODE version of the message
         <Spanish> the Spanish UNICODE version of the message
   <content>—if the field's source is script (meaning it is not mapped to a backend system), values can be assigned to the field which will appear in the client application. This element contains 1 to N of the following child elements:
      <value>—text value (if a field is of type textbox, it will only contain 1<value> element)

Summary of BRI Based Actions

In summary the BRI currently provides the ability to change properties of objects that exists on the agent UI. It can also provide programmatic instructions to the agent UI such as informing the agent UI not allow a particular CLM or to generate an automated CLM. However, unique to the BRWS is that every action can be supplemented with user intervention. An embodiment may implement objects using Plain Old Java Objects (POJO).

As an example it is possible that when CLM “x” is received by the UI that the user is prompted “There is currently an automated message that is to occur, would you allow this automated message?” A subsequent response to this YES/NO type of action would allow the user to decide if an automated message should occur. This feature makes the BRWS unique from other workflow or business process management applications.

Example Usage of the Preferred Embodiment of the BRI

Overview

To help understand how to apply the BRI against an actual CLM, a sample BRI in XML and sample CLM are provided in this section. This example will illustrate the following elements:
CTI begin call message—This is a sample telephony “Begin call” message from a CTI server. Basically, in the telephony world a “Computer Telephony Interface” or CTI is a gateway interface into a call routing system. Telephony events, such as a new call arriving on an agent desktop, are routed as messages in the CTI BackOffice. These messages will be transformed into CLM messages by the BOA Server. This message is a prime example of a CLM message with custom data elements that can be utilized in the agent UI.
Matching client incoming CLM with CLM defined in BRI. This example shows what fields must be matched to begin the process of applying the BRI rules to the message.
Condition and Question evaluations—This example contains both <condition>and <question> tags which illustrate how a workflow can take different paths depending on message data and user input evaluations.
Functional screens—The nested conditions will drive the workflow to either a New Order screen or an account Verification Screen.
Screen and field based messages—Shows how screens and fields on screens can have dialog and/or instructional messages associated with them.
Workflow sequencing—Illustrates how screens and conditional elements can be nested under other screens and conditional elements to drive a workflow based on the incoming message.
Fields and actions—Shows fields defined on screens and associated event actions.

Note that it is important to understand that this example shows how to interpret the preferred embodiment of the BRI rules in XML in order to determine a workflow and what actions must be performed by the client application. However, this example works on a high level, only showing the logic which must be employed by the agent UI. It does not show how to implement this logic in actual client code. This responsibility of the agent UI developer and is outside the boundary of the BRWS. For example, a <screen_message> tag contains text which must be presented to the user when a particular screen is opened in the client application. The <screen_message> tag does not, however, say HOW this message should be displayed. Also, this example does not show how to display the message in code, leaving it up to the discretion of the agent UI developer to display how they determine it should be done.

To aid in the evaluation of the BRI, the Client Toolkit (300) or CTK contains a subcomponent called the Client Script Evaluator (300b) or CSE. This can be utilized by .Net, Web, or java language agent UI applications to automatically perform the workflow rules evaluations that will be shown in the following walk-thru examples. When a workflow node requires user interaction, a Script Event (350) will be raised in the agent UI by the SE (300b). This SE (350) has all the necessary information for the agent UI to handle implementing the logic of the requested workflow action.

However, since the agent UI does not have to utilized the SE (300a), the BRI evaluation and usage can be handled manually thru the agent UI entirely. The following walk-thru examples show the kind of evaluation of the BRI (400) that result regardless of whether the workflow evaluation is handled automatically by the SE (300b) or the agent Ul.

Sample Data

The following two sample XML sections show a sample CLM for a telephony ‘Begin Call’ event and a sample embodiment of the BRI in XML. These will be used for the example walk-thru.

Sample CTI “BeginCall” XML CLM

```
<Message>
  <Category>23</Category>
  <SubCategory>1</SubCategory>
  <Function>2</Function>
  <Body>
```

<aNI>2</aNI>
<callerEnteredDigits>11234</callerEnteredDigits>
<callType>1</callType>
<callWrapupData />
<connectionCallID>8</connectionCallID>
<connectionDeviceID>123</connectionDeviceID>
<connectionDeviceIDType>1</connectionDeviceIDType>
<cTIClientSignature />
<cTIClientTimestamp />
<dialedNumber>8001234567</dialedNumber>
<dNIS />
<messageLength />
<messageType />
<monitorID>777</monitored>
<namedArray />
<namedVariable />
<numCTIClients />
<numNamedArrays>0</numNamedArrays>
<numNamedVariables>0</numNamedVariables>
<peripheralID>555</peripheralID>
<peripheralType>1</peripheralType>
<routerCallKeyCallID />
<routerCallKeyDay />
<userToUserInfo />
<acctFirstName>Bob</acctFirstName>
<acctLastName>Smith</acctLastName>
<acctNumber>999999</acctNumber>
<acctStatus>1</acctStatus>
<addr1>123 Elm St.</addr1>
<addr2 />
<callerType>1</callerType>
<city>Los Angeles</city>
<dob>05/12/65</dob>
<maiden>Smith</maiden>
<phone1>555-123-1212</phone>
<ssn>555-123-1234</ssn>
<state>CA</state>
<verifyFlag>T</verifyFlag>
<zip>80111</zip>

</Body>
</Message>

Sample BRI XML

```
<root version=“2.0”>
  <ejb ID=”999”>
    <mincategory>0</mincategory>
    <maxcategory>115</maxcategory>
    <message ID=“999”>
      <category>23</category>
      <subcategory>1</subcategory>
      <function>2</function>
      <field_datatypes>
        <aNI>string</aNI>
        <callerEnteredDigits>string</callerEnteredDigits>
        <callType>int</callType>
        <callWrapupData>string</callWrapupData>
        <connectionCallID>int</connectionCallID>
        <connectionDeviceID>string</connectionDeviceID>
        <connectionDeviceIDType>int</connectionDeviceIDType>
        <cTIClientSignature>array</cTIClientSignature>
        <cTIClientTimestamp>array</cTIClientTimestamp>
        <dialedNumber>string</dialedNumber>
        <dNIS>string</dNIS>
        <messageLength>long</messageLength>
        <messageType>long</messageType>
        <monitorID>int</monitorID>
        <namedArray>array</namedArray>
        <namedVariable>array</namedVariable>
        <numCTIClients>int</numCTIClients>
        <numNamedArrays>int</numNamedArrays>
        <numNamedVariables>int</numNamedVariables>
        <peripheralID>int</peripheralID>
        <peripheralType>int</peripheralType>
        <routerCallKeyCallID>int</routerCallKeyCallID>
        <routerCallKeyDay>int</routerCallKeyDay>
        <userToUserInfo>string</userToUserInfo>
        <acctFirstName>string</acctFirstName>
        <acctLastName>string</acctLastName>
        <acctNumber>int</acctNumber>
        <acctStatus>int</acctStatus>
        <addr1>string</addr1>
        <addr2>string</addr2>
        <callerType>string</callerType>
        <city>string</city>
        <dob>string</dob>
        <maiden>string</maiden>
        <phone1>string</phone1>
        <ssn>string</ssn>
        <state>string</state>
        <verifyFlag>string</verifyFlag>
        <zip>string</zip>
      </field_datatypes>
      <condition ID=“123”>
        <case ID=“1111”>
          <expression>{verifyFlag}=‘T’</expression>
          <screen ID=“1000”>
            <screen_message>
              <font_color>red</font_color>
              <english>Remind the caller about this weeks 2 for 1 special on
widgets.</english>
              <alt_language />
            </screen_message>
            <field ID=“”>
              <xmltag>order number</xmltag>
              <type>tb</type>
            </field>
            <field ID=“”>
              <xmltag>item_number</xmltag>
              <type>tb</type>
            </field>
            <field ID=“”>
              <xmltag>item_description</xmltag>
              <type>tb</type>
            </field>
            <field ID=“”>
              <xmltag>quantity</xmltag>
              <type>tb</type>
            </field>
            <field ID=“”>
              <xmltag>ship_method</xmltag>
              <type>cb</type>
              <content>
                <value code=“”>$5.99 - ups ground</value>
                <value code=“”>$15.99 - fedex 2nd day</value>
                <value code=“”>$0 - in-store pickup</value>
              </content>
              <action ID=“”>
                <type>edit dialog/instruction</type>
                <event>update</event>
                <target xmltag=“ship_method”>ship_method</target>
                <cond_value>$5.99 - ups ground</cond_value>
                <field_message>
                  <dialog>
                    <font_color>blue</font_color>
                    <english />
                    < alt_language />
                  </dialog>
                  <instruction>
                    <font_color>blue</font_color>
                    <english>Check the shipping address - ups won't ship to a po
box.</english>
                    < alt_language >Compruebe la direcciÃ³n del envÃ-o - sube no
enviar [symbol] a una caja del po.</ alt_language>
                  </instruction>
                </field_message>
              </action>
            </field>
            <field ID=“307”>
              <xmltag>acctNumber</xmltag>
              <type>tb</type>
            </field>
          </screen>
        </case>
        <case ID=“555”>
          <expression />
          <screen ID=“1001”>
            <screen_message>
              <font_color>black</font_color>
              <english>The caller must identify 2 out of 3 from ssn, address, mothers
maiden name, dob.</english>
              < alt_language />
            </screen_message>
            <field ID=“305”>
              <xmltag>acctFirstName</xmltag>
              <type>tb</type>
            </field>
            <field ID=“306”>
              <xmltag>acctLastName</xmltag>
              <type>tb</type>
            </field>
            <field ID=“307”>
              <xmltag>acctNumber</xmltag>
              <type>tb</type>
            </field>
            <field ID=“309”>
              <xmltag>addr1</xmltag>
              <type>tb</type>
            </field>
            <field ID=“310”>
              <xmltag>addr2</xmltag>
              <type>tb</type>
            </field>
            <field ID=“311”>
              <xmltag>city</xmltag>
              <type>tb</type>
            </field>
            <field ID=“314”>
              <xmltag>dob</xmltag>
              <type>tb</type>
            </field>
            <field ID=“316”>
              <xmltag>maiden</xmltag>
              <type>tb</type>
            </field>
            <field ID=“317”>
              <xmltag>phone1</xmltag>
              <type>tb</type>
            </field>
            <field ID=“315”>
              <xmltag>ssn</xmltag>
              <type>tb</type>
            </field>
            <field ID=“312”>
              <xmltag>state</xmltag>
              <type>tb</type>
            </field>
            <field ID=“313”>
              <xmltag>zip</xmltag>
              <type>tb</type>
            </field>
            <question ID=“456”>
              <question_text>Was the caller able to verify the account
information?</question_text>
              <question_yes>
                <screen ID=“1000”>
                  <screen_message>
                    <font_color>red</font_color>
                    <english>Remind the caller about this weeks 2 for 1 special on
widgets.</english>
                    < alt_language />
                  </screen_message>
                  <field ID=“”>
                    <xmltag>order number</xmltag>
                    <type>tb</type>
                  </field>
                  <field ID=“”>
                    <xmltag>item_number</xmltag>
                    <type>tb</type>
                  </field>
                  <field ID=“”>
                    <xmltag>item_description</xmltag>
                    <type>tb</type>
                  </field>
                  <field ID=“”>
                    <xmltag>quantity</xmltag>
                    <type>tb</type>
                  </field>
                  <field ID=“”>
                    <xmltag>ship_method</xmltag>
                    <type>cb</type>
                    <content>
                      <value code=“”>$5.99 - ups ground</value>
                      <value code=“”>$15.99 - fedex 2nd day</value>
                      <value code=“”>$0 - in-store pickup</value>
                    </content>
                    <action ID=“”>
                      <type>edit dialog/instruction</type>
                      <event>update</event>
                      <target xmltag=“ship_method”>ship_method</target>
                      <cond_value>$5.99 - ups ground</cond_value>
                      <field_message>
                        <dialog>
                          <font_color>blue</font_color>
                          <english />
                          < alt_language />
                        </dialog>
                        <instruction>
                          <font_color>blue</font_color>
                          <english>Check the shipping address - ups won't ship to a po
box.</english>
                          < alt_language >Compruebe la direcciÃ³n del envÃ-o - sube no
enviar [symbol] a una caja del po.</ alt_language >
                        </instruction>
                      </field_message>
                    </action>
                  </field>
                  <field ID=“307”>
                    <xmltag>acctNumber</xmltag>
                    <type>tb</type>
                  </field>
                </screen>
              </question_yes>
              <question_no>
                <script_event ID=“”>
                  <name>customer service notification</name>
                  <description />
                  <type>0</type>
                  <event_parameters>
                    <script_message>Orders cannot be placed on an account without
proper verification. Please call the customer service center at 800-123-4567.
</script_message>
                  </event_parameters>
                </script_event>
              </question_no>
            </question>
          </screen>
        </case>
      </condition>
    </message>
  </ejb>
</root>
```

Example Walk-thru

This example shows how BRI rules stored in XML can drive the agent UI workflow. Specifically to a New Order screen, so an order can be taken for the caller. There are 2 pathways to this screen, based on whether the caller was able to be security verified by the IVR (interactive phone menu system) or not. If the caller was verified, the agent UI should then directly open the New Order screen after the Begin Call message arrives. If the caller was not verified, then the agent UI should open a security Verification screen. This will allow the caller to verify the account information such as SSN or mother's maiden name. If the caller was able to successfully verify their account information, then the New Order screen can be opened. If the caller was unable to verify the account information, then the agent UI should present a message which contains a customer service number which must be given to the caller. No New Order screen will be presented in this case.

Scenario 1—Caller is Verified

In this example, we will assume that the caller was verified by the IVR system, which means the verifyFlag field in the Begin Call message has a value of ‘T’.
1. New CLM arrives on the client.

2. Find matching <message> node in the BRI—The new message has the following identifying tags and values in the message header:

<Category>23</Category>
<SubCategory>1</SubCategory>
<Function>2</Function>

Using these three tag values, the matching message can be found in the BRI XML file. In this case, the matching message node is the only <message>node in the BRI, but normally there would be many messages. All messages, however, must have a unique combination of category, subcategory, and function.
Also, note that the parent <ejb> node represents the BOA the CLM is associated with. Using just the category, subcategory, and function, the correct CLM can be found regardless of the parent <ejb> node. This is because the combination of these 3 values must be unique for ALL CLM, regardless of parent ejb. So, the parent <ejb> node does not have to be known, and all messages of all <ejb> nodes can be searched and the correct message will be found. However, given the category, the search can be made more efficient by narrowing the search to the correct parent <ejb> node. Since the category value of the incoming message will be contained in the correct range of the <mincategory> and <maxcategory> tags of the <ejb> node, only messages under this node need be searched.
3. Get next sequence node—The <message> node should have 1 and only 1 of the following childnodes: <condition>, <question>, <screen>, or <script_event>. In this case, it is a <condition> tag, which means a conditional evaluation will take place.
4. Evaluate <case> nodes of <condition>—Now that we have the <condition> node, we need to evaluate the child <case> nodes. Specifically, each <case> node has a child <expression> node, which contains an expression based on the message fields which must be evaluated. So, now we need to iterate thru the <case> nodes and evaluate each child <expression> until either we find one that evaluated to True, or we reach the last or default <case> node. The last <case> node contains null for the <expression>, since this is the default case that is used if all the other <case> node expressions evaluate to false. In our example, the first <case> node with a ID of 111 (<case ID=“111”>) has an expression: “{verifyFlag}=‘T’”. This instructs the agent UI to obtain the value of the verifyFlag field in the Begin Call message and test to see if the value equals ‘T’. If it does, then this <case>evaluates to True, and this is the workflow path to follow. In the given sample Begin Call message, the verfiyFlag value is indeed ‘T’, so this <case> node will be the node we drill into to continue the workflow.
5. Get next sequence node—The <case> node should have 1 and only 1 of the following childnodes: <condition>, <question>, <screen>, or <script_event>. In this case, it is a <screen> tag, which means the client application should display a screen.
6. Open the Order Screen—The client will now open a screen which corresponds to the <screen ID=“1000”> tag. Also, since the <screen> node has a child <screen_message>, the agent UI should display a message contained in the <english> child tag of the <screen_message> node. The message is “Remind the caller about this weeks 2 for 1 special on widgets.”
7. Apply scripting to the screen fields—Now that we have the <screen> node, we can get all the child <field> nodes to apply BRI rules against these fields. These <field> tags all represent textboxes and/or comboboxes in the agent UI on the New Order screen. If the screens are pre-built, then matches between existing textbox/comboboxes will need to be made to know which <field> tags are associated with which controls on the screen. Most likely the <xmltag> value will be used to match to an existing control name or other property. If the screens are not pre-built, then the <field> tags represent the textboxes/comboboxes which must be created on the screen.

In the sample BRI XML, only 1 field contains tags which need to be applied to a control on a screen; the <field> with the <xmltag> value of “ship_method”. This <field> tag has a <type> of “cb” for combobox and <source> of “script”, which means it's a combobox whose values are determined by the BRI. In this case, the items used to populate the combobox (list items) need to be applied from the BRI. The field has the following content:

```
<content>
    <value code=“”>$5.99 - ups ground</value>
    <value code=“”>$15.99 - fedex 2nd day</value>
  <value code=“”>$0 - in-store pickup</value>
</content>
```

So, the combobox should be filled with the above 3 values, and the first item should be the default value. This field also has an <action> child tag. Actions are work that needs to be performed based on some event. In this case, the <action> tag has a <type> of “edit dialog/instruction”, which means that the field message of a specified control will be updated based on this combobox being updated to a specific value designated by the <cond_value> tag, in this case “$5.99—ups ground”. The <event> tag has a value of “update”, which is how we know to apply this action on the update event of this control (in VB, the “selectedindex_changed” event is used for listboxes and comboboxes to designate that a selection has been made from the list of items in the control). Since this is action has a type of “edit dialog/instruction”, when the triggering event occurs, the client agent UI needs to change the <field_message> (and all child fields under <dialog> and <instruction>) to the corresponding values specified by the <field_message> tag of the <action>. The target control to apply this to is specified in the <target> tag. In this case, the target is the same control as the one where the action is applied, the control with xmltag of “ship_method”. So, in simple terms, when a user selected “$5.99—ups ground” from the list of items in the combobox, the associated dialog and instruction properties of the combobox should be updated to reflect the new values. In this case, there is a new <instruction> value which warns the user to check the address, as well as a new <font_color> value of blue.
Since <action> tags represent actions which must be done based on some user input event, such as selection or updating, the work of a <action> tag cannot be applied ahead of time to a control. In other words, if an action defined some bit of work to be done based on updating a control, then nothing can be applied until this event happens. So, to store what actions must be performed on a control when a specific event happens, 2 things are required. First, the list of actions which must be performed based on an event of a control must be stored and associated with that control, so that at runtime when a user triggers the event, the associated action can be performed. Also, a custom even handler needs to be written for that control's specified event to handle performing the work of the action. The Client Toolkit or CTK (300) contains custom textbox and combobox controls (in .Net) which contain custom properties to store actions for later use.
8. Apply message data—Now that the screen has been found and the scripting applied to the screen and its controls, the final step before opening the screen is to apply the CLM data. This means every field tag in the Begin Call CLM message should be check against the controls on the New Order screen. In the Begin Call message, each field tag's name is the value used to match to a corresponding control (textbox or combobox) on the New Order screen. This value can be stored as the control name or some other property. In our example, only 1 field on the New Order screen is a message field: <acctNumber>999999</acctNumber>. So, this value is used to populate the corresponding account number textbox on the New Order screen.
9. Open the screen—Now that all the BRI XML and CLM data has been applied to the screen, now it can be opened and used by the user. When the user is done working with this screen, the screen is closed. At this time, any request CLM which needs to go to the server are sent. In the case of the New Order screen, request message(s) needs to be sent to a back office server to record the new order. Additionally, confirmation messages may be sent from the server to the client. These confirmation messages could have BRI rules and a workflow defined on them as well, however, in this example there are no rules setup for the confirmation messages.
10. Get next sequence node—The <screen> node can possibly have 1 and only 1 of the following childnodes: <condition>, <question>, <screen>, or <script_event>. This would represent the next decision or course of action to take in the workflow of the BRI. In this case none of these tags exist, meaning there is nothing further to do in the workflow.

Scenario 2—Caller is Not Verified

In this example, we will assume that the caller was not verified by the IVR system, which means the verifyFlag field in the Begin Call message has a value of ‘F’.
1. Steps 1-5 are the same as in the previous example.
2. Evaluate <case> nodes of <condition>—Now that we have the <condition> node, we need to evaluate the child <case> nodes. Specifically, each <case> node has a child <expression> node, which contains an expression based on the message fields which must be evaluated. So, now we need to iterate thru the <case> nodes and evaluate each child <expression> until either we find one that evaluated to True, or we reach the last or default <case> node. The last <case> node contains null for the <expression>, since this is the default case that is used if all the other <case> node expressions evaluate to false. In this scenario, we are assuming that the value of <verifyFlag> in the Begin Call message is NOT “T”, but rather is “F”. So, this means that the expression “{verifyFlag}=‘T’”, evaluated to False. So, the first <case> tag is ignored, and since there is only 1<case> tag left (the default case), then this is the second <case> tag is used to drill into to continue the workflow.
3. Get next sequence node—The <case> node should have 1 and only 1 of the following childnodes: <condition>, <question>, <screen>, or <script_event>. In this case, it is a <screen> tag, which means the agent UI opens a screen.
4. Open the Verification Screen—The agent UI will now open a screen which corresponds to the <screen ID=“1001”> tag. Also, since the <screen> node has a child <screen_message>, the agent UI should display a message contained in the <english> child tag of the <screen_message> node. The message is “Remind the caller about this weeks 2 for 1 special on widgets.”
5. The next set of steps of applying BRI rules, event actions, and CLM data are the same as the previous example, but with different data (steps 6-9 in the previous example). Since the steps are the same, but just the data is different, these steps will not be detailed specifically here.
6. Get next sequence node—The <screen> node can possibly have 1 and only 1 of the following childnodes: <condition>, <question>, <screen>, or <script_event>. This would represent the next decision or course of action to take in the workflow of the BRI. In this case there is a <question>, which means the next item in the workflow is to ask the user an interactive question.
7. Ask the user question—The <question> tag instructs the agent UI to present a yes/no question to the user. This would typically be a dialog box, but can be implemented however the agent UI developer desires. The text of the question is contain in the <question text> tag, which in this case is “Was the caller able to verify the account information?”. The user will give a ‘Yes’ or ‘No’ response. This will tell the workflow which is the next step, the corresponding <question_yes> or <question_no> child tag.
   If the user responds with ‘Yes’, then the <question_yes> tag will be used. In this case, the <question_yes> tag contains a <screen> child tag, which means the next step will be to open a screen. In this case, it is the same New Order screen opened in the previous example. Since the steps would be the same as the previous example (steps 6-9), we won't go into that detail here.
   If the user responds ‘No’, then the <question_no> tag will be used. In this case, the <question_no> tag contains a <script_event> child tag, which means a script event must be executed as the next step in the workflow.
8. Perform the script event—In this case, the <script_event> has a <type> value of 0, which means is a display_messagebox type of script event. This means that the client application should display a text message to the user with the specified text. This message would typically be displayed in a dialog box or similar object. The text is contained in the <script_message> tag under the <event_Parameters> tag. The <event_parameters> tag just contains any parameters used by the type of script event, in this case just a message to display. In this example the text would be “Orders cannot be placed on an account without proper verification. Please call the customer service center at 800-123-4567.”.

The various embodiments therefore provide that a single end user interface application may be coded to use an instance of an embodiment of the business rules interface. An embodiment may further be configured to handle all workflow for the entire back office space. Thus, as new back office applications are added, no code changes in the business rules interface or client application are required to handle the new back office application, in stark contrast to the current workflow environment. In an embodiment a higher-powered server controls the proprietary communication to the back office space and the various proprietary back office applications, hence, companies may still use company created proprietary back office applications without being forced to purchase a proprietary workflow solution. All communications with any back office application is controlled through the business rules interface. Instead of being disconnected from the communication model, the business rules are brought in synch with changes to the back office applications, and since the business rules are separated and not imbedded in the agent user interface, changes to the business rules may be made on the fly. All communication with the agent user interface is accomplished via a single connection point, using a “non-proprietary” communication model. In an embodiment the agent user interface becomes “thin”, heavy programming is removed from the application running on the low powered PC of the agent/employee, yet the agent/employee is regulated through the separate business rules which may change on the fly. Also, there is one common message format and set of business rules that control the workflow of the client application, regardless of which back office application is being utilized.

An embodiment overcomes the disadvantages and limitations of the prior art by providing a single communication interface for communications between end user applications, such as an agent user interface, and back office applications. The single communication interface precludes the need to create the numerous communication applications necessary for each different back office application and each different end user application. The creation of a communications interface for a back office or an end user application may take a significant amount of programming time and expense. An embodiment also provides a single interface to apply business rules to the end user application to back office application communications. These interfaces reduce the need for multiple user interfaces using multiple technologies, thus reducing the complexity, maintenance, and upgrade costs for a typical business environment. Further, an embodiment may be a platform independent, distributed, server deployed application.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of optimizing back office enterprise computer systems to end user computer systems workflow comprising:
concentrating workflow communication messages that are transmitted to and from at least one back office application into a single common communication format that is accessible by at least one end user computer application;
communicating said workflow communication messages directly to and from said at least one end user computer application in said single common communication format such that said workflow communication messages are not converted into an end user application format prior to being communicated to said at least one end user computer application; and
applying user configured business rules to said workflow communication messages formatted with said single common communication format such that said at least one end user computer application behaves in accordance with said user configured business rules.

2. The method of claim 1 further comprising translating said workflow communication messages that are transmitted to and from said at least one back office application into and out of said common communication format using a BOA Server in order to facilitate communication with said at least one end user computer application.

3. The method of claim 2 further comprising using a client toolkit to assist said at least one end user computer application in sending and receiving said workflow communication messages formatted in said common communication format and to assist said at least one end user computer application in applying said configured business rules to said workflow communication messages.

4. The method of claim 3 further comprising supplying client connection classes in said client toolkit in order to provide the structure for said workflow communication messages formatted in said common communication format to said at least one end user computer application to assist in sending and receiving said workflow communication messages formatted in said common communication format.

5. The method of claim 4 wherein said client connection classes are implemented with Plain Old Java Objects (POJO) and said common communication format is implemented with extensible Markup Language (XML).

6. The method of claim 3 further comprising applying said user configured business rules to said workflow communication messages via a client script evaluator by sending script events to request that actions be performed by said at least one end user computer application and reading and evaluating responses of said at least one end user computer application to said script events.

7. The method of claim 1 wherein said step of applying user configured business rules to said workflow communication messages further comprises using a business rules graphical user interface application to obtain business rule information from said workflow communication messages and to permit an end user to configure business rules that govern operation of said at least one end user computer application in regards to said workflow communication messages such that said step of applying user configured business rules to said workflow communication messages is controlled by said business rules graphical user interface application.

8. The method of claim 1 wherein said method for optimizing back office enterprise computer systems to end user computer systems workflow is implemented as platform independent, distributed, server deployed software applications.

9. The method of claim 1 wherein said method for optimizing back office enterprise computer systems to end user computer systems workflow performs Computer Telephony Integration (CTI).

10. A business rules workflow system for optimizing back office enterprise computer systems to end user computer systems workflow comprising:
a common language message subsystem that concentrates workflow communication messages that are transmitted to and from at least one back office application into a single common communication format that is accessible by at least one end user computer application; and
a communication subsystem that communicates said workflow communication messages directly to and from said at least one end user computer application in said single common communication format such that said workflow communication messages are not converted into an end user application format prior to being communicated to said at least one end user computer application; and
a business rules interface subsystem that applies user configured business rules to said workflow communication messages that are formatted with said single common communication format such that said at least one end user computer application behaves in accordance with said user configured business rules.

11. The business rules workflow system of claim 10 further comprising a BOA Server capable of translating said workflow communication messages that are transmitted to and from said at least one back office application into and out of said common communication format in order to facilitate communication with said at least one end user computer application.

12. The business rules workflow system of claim 11 further comprising a client toolkit subsystem that interacts with said at least one end user computer application, said client toolkit subsystem assisting said at least one end user computer application in sending and receiving said workflow communication messages formatted in said common communication format and assisting said at least one end user computer application in applying said configured business rules to said workflow communication messages.

13. The business rules workflow system of claim 12 wherein said client toolkit subsystem further comprises client connection classes that provide the structure for said workflow communication messages formatted in said common communication format to said at least one end user computer application in order to assist in sending and receiving said workflow communication messages formatted in said common communication format.

14. The business rules workflow system of claim 13 wherein said client connection classes are implemented with Plain Old Java Objects (POJO).

15. The business rules workflow system of claim 13 wherein said common communication format is implemented with extensible Markup Language (XML).

16. The business rules workflow system of claim 12 wherein said client toolkit subsystem further comprises a client script evaluator subsystem that applies said user configured business rules to said workflow communication messages by sending script events to request that actions be performed by said at least one end 5 user computer application and reading and evaluating responses of said at least one end user computer application to said script events.

17. The business rules workflow system of claim 10 wherein said business rules interface subsystem further comprises a business rules graphical user interface application that obtains business rule information from said workflow communication messages and permits an end user to configure business rules that govern operation of said at least one end user computer application in regards to said workflow communication messages such that said business rules interface subsystem is configured by said business rules graphical user interface application.

18. The business rules workflow system of claim 10 wherein said common language message subsystem, said communication subsystem, and said business rules interface subsystem are implemented as platform independent, distributed, server deployed software applications.

19. The business rules workflow system of claim 10 wherein said business rules workflow system is incorporated in a Computer Telephony Integration (CTI) system.

20. A business rules workflow system for optimizing back office enterprise computer systems to end user computer systems workflow comprising:
means for concentrating workflow communication messages that are transmitted to and from at least one back office application into a single common communication format that is accessible by at least one end user computer application;
means for communicating said workflow communication messages directly to and from said at least one end user computer application in said single common communication format such that said workflow communication messages are not converted into an end user application format prior to being communicated to said at least one end user computer application; and
means for applying user configured business rules to said workflow communication messages formatted with said single common communication format such that said at least one end user computer application behaves in accordance with said user configured business rules.
